(19) United States
(12) Patent Application Publication
(10) Pub. No.: US 2010/0202552 A1
(43) Pub. Date: Aug. 12, 2010

(54) OFDM DEMODULATOR, OFDM DEMODULATION METHOD, OFDM DEMODULATION PROGRAM, AND STORAGE MEDIUM

(75) Inventors: Atsushi Sakai, Osaka (JP); Arnaud Santraine, Osaka (JP); Akira Saito, Osaka (JP); Masayuki Natsumi, Osaka (JP); Mamoru Okazaki, Osaka (JP); Kazumasa Kioi, Osaka (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi, Osaka (JP)

(21) Appl. No.: 12/599,904

(22) PCT Filed: May 14, 2008
(86) PCT No.: PCT/JP2008/058802

§ 371 Date: Nov. 12, 2009

(30) Foreign Application Priority Data
May 14, 2007 (JP) 2007-128457

(51) Int. Cl. H04L 1/02

(52) U.S. Cl. 375/267

(57) ABSTRACT

In a case where there are a plurality of spurious disturbing waves, each of which has a strong peak at a particular frequency, in a transmission band, correlation between the disturbing waves becomes nonconstant so that it becomes difficult to remove the correlation between the disturbing waves. An OFDM demodulator of the present invention includes a symbol integration circuit (131) for integrating a guard correlation signal in a symbol number direction, and an offset removal circuit (132) for removing an offset from the guard correlation signal integrated in the symbol number direction. An amplitude component due to the disturbing wave, which amplitude component is included in the guard correlation signal, is cancelled by the integration in the symbol number direction, so that it is possible to successfully remove the offset from the guard correlation signal. Therefore, it is possible to obtain symbol timing more precisely by use of a maximum value detecting circuit (124), and further, calculate a phase rotation amount more precisely by use of a phase finding circuit (125).

### TECHNICAL FIELD

The present invention OFDM (Orthogonal Frequency Division Multiplexing: hereinafter, referred to as “OFDM”) demodulator; an OFDM demodulation method; and an OFDM demodulation program, each of which demodulates a received signal by the OFDM. The present invention further relates to a computer-readable storage medium in which such an OFDM demodulation program is stored.

### BACKGROUND ART

There has been known that terrestrial digital broadcasting employs a multicarrier OFDM modulation/demodulation method, as a modulation method that is suitable to cope with ghosting generated by existence of buildings, such as: multipathing, that is, attenuation of a signal due to interference between a wave reflected by a building or the like, and a direct wave; and fading, that is, attenuation of a signal due to interference between the waves thus reflected.

The OFDM modulation/demodulation method is a digital modulation/demodulation method which is capable of efficiently transmitting an image signal or a sound signal by providing a large number (approximately 256-1024) of sub-carriers in 1 channel band.

In the OFDM modulation method, IFFT (Inverse Fast Fourier Transform) is carried out with respect to all carriers so as to generate an OFDM-modulated baseband (BB) signal.

FIG. 15 is a view illustrating an arrangement of a transmission symbol 300 of an OFDM modulation wave. The transmission symbol 300 includes an effective symbol 301. In the present specification, “Tu” is an effective symbol period (length of a period of the effective symbol 301). The IFFT is carried out such that an IFFT processing period is identical with the effective symbol period Tu. A sum of all carriers that are digital-modulated, which sum is obtained by using the effective symbol 301 as a base unit, is called “OFDM transmission symbol”.

In addition to the effective symbol 301, the transmission symbol 300, in practice, generally includes a guard interval 302, as illustrated in FIG. 15. In the present specification, “Tg” is a guard interval period (length of a period of the guard interval 302). A signal waveform of the guard interval 302 is a copy of a part (a part 303 shown in a dotted pattern) of the effective symbol 301. A transmission symbol period (length of a period of the transmission symbol 300) Ts is a sum of the effective symbol period Tu and the guard interval period Tg.

According to a broadcast standard described in Non-Patent Literature 1, the effective symbol period Tu is defined by a parameter called “MODE”, as shown in the following Chart 1.

CHART 1

| | EFFECTIVE SYMBOL PERIOD LENGTH tₛ |
|---|---|
| MODE | μsec |
| 1 | 252 |
| 2 | 504 |
| 3 | 1008 |

Further, the guard interval period (unit:μs) is defined by a parameter called “GI period length (GI ratio)” which is a ratio of the guard interval period to each of the effective symbol period, as shown in the following Chart 2.

CHART 2

| | GI PERIOD LENGTH tₛ | | |
|---|---|---|---|
| GI RATIO | μsec | | |
| g | MODE 1 | MODE 2 | MODE 3 |
| 1/4 | 63 | 126 | 252 |
| 1/8 | 31.5 | 63 | 126 |
| 1/16 | 15.75 | 31.5 | 63 |
| 1/32 | 7.875 | 15.75 | 31.5 |

Furthermore, a collection of a plurality of transmission symbols is called “transmission frame”. The transmission frame is a collection of approximately 100 information transmission symbols, to which collection a frame synchronous symbol or a service identification symbol is added. For example, in Non-Patent Literature 1, there is a definition that 1 frame is constituted by 204 symbols.

Further, according to Non-Patent Literature 1, in 1 transmission symbol that has been subjected to QPSK, 16QAM, or 64QAM modulation, carriers shown in the following Chart 3 are arranged per 1 segment.

CHART 3

| SORT OF | SIGNAL | THE NUMBER OF CARRIERS | | |
|---|---|---|---|---|
| CARRIER | INTENSITY | MODE 1 | MODE 2 | MODE 2 |
| DATA | 1 | 96 | 192 | 384 |
| SP | 4/3 | 9 | 18 | 36 |
| TMCC | 4/3 | 1 | 2 | 4 |
| AC1 | 4/3 | 2 | 4 | 8 |

In Chart 3, “SP” is an SP (Scattered Pilot) signal. This SP signal is a pilot signal which is periodically inserted into the transmission symbol. For example, the SP signal is inserted once in 12 carriers in a carrier direction, and once in 4 symbols in a symbol direction.

A TMCC (Transmission and Multiplexing Configuration Control) signal is a signal for transmitting a frame synchronous signal or a transmission parameter.

An AC (Auxiliary Channel) 1 signal is a signal for transmitting additional information. Unlike the SP signal, the TMCC signal and the AC1 signal are arranged in each carrier non-periodically.

Next, the following description explains a conventional OFDM demodulator with reference to FIGS. 16 through 19.

FIG. 16 is a block diagram illustrating an arrangement of a conventional OFDM demodulator 100, which arrangement is based on “desirable specifications” described in Non-Patent Literature 1.

As illustrated in FIG. 16, the OFDM demodulator 100 includes an OFDM demodulation LSI (Large Scale Integrated Circuit) 101, an antenna 102, and a tuner 103. Further, the OFDM demodulation LSI 101 includes, inside thereof, a baseband signal processing section 104 and an error correction processing section 116.

The baseband signal processing section 104 includes: an analogue-digital converter (ADC) 105; an orthogonal demodulation circuit 106; a carrier frequency error correction circuit 107; an AGC (Automatic Gain Control) circuit 108; a symbol synchronous circuit 109; a narrowband carrier frequency error detecting circuit 110; an NCO (Numerically-Controlled Oscillator) 111; an FFT calculation circuit 112; a TMCC decoding circuit 113; a broadband carrier frequency error detecting circuit 114; and a waveform equalization circuit 115.

A broadcast wave of a digital broadcast is received from a broadcast station by the antenna 102 of the OFDM demodulator 100, and then is supplied to the tuner 103 as an RF (Radio Frequency) signal. The tuner 103 carries out frequency conversion with respect to each RF signal received by the antenna 102, so as to convert the RF signal into an IF (Intermediate Frequency) signal. The tuner 103 supplies the IF signal thus frequency-converted to the ADC 105 provided in the baseband signal processing section 104.

The ADC 105 digitalizes the IF signal received from the tuner 103. The IF signal thus digitalized is supplied to the orthogonal demodulation circuit 106.

The orthogonal demodulation circuit 106 carries out orthogonal demodulation with respect to the IF signal thus digitalized, by use of a carrier signal having a predetermined frequency (carrier frequency), and outputs a baseband OFDM signal. As a result of the orthogonal demodulation, the baseband OFDM signal becomes a complex signal constituted by a real axis component (I channel signal) and an imaginary axis component (Q channel signal). The orthogonal demodulation circuit 106 outputs the baseband OFDM signal to the carrier frequency error correction circuit 107.

The carrier frequency error correction circuit 107 carries out complex multiplication of the baseband OFDM signal outputted from the digital orthogonal demodulation circuit 106 and a frequency correction signal (complex signal) outputted from the NCO 111, thereby correcting deviation of a center frequency of the OFDM signal.

Generally, in the OFDM demodulation, two sorts of carrier frequency error are detected independently. The two sorts of carrier frequency error thus detected are added, and the resultant sum is provided to the NCO 111 as a control signal. One of the two sorts of carrier frequency error is a broadband carrier frequency error, which is a frequency error in an accuracy of a frequency interval between the sub-carriers. The other sort is a narrowband carrier frequency error, which is a frequency error in an accuracy of ±1/2 or less of the frequency interval between the sub-carriers.

The broadband carrier frequency error detecting circuit 114 extracts the pilot signal from each of the sub-carriers that have been subjected to FFT calculation, and detects the broadband carrier frequency error based on the pilot signal thus extracted. The broadband carrier frequency error thus detected is inputted into the NCO 111.

The narrowband carrier frequency error detecting circuit 110 detects a phase rotation amount corresponding to an amount of the deviation of the center frequency of the OFDM signal, which center frequency is not more than a carrier frequency of the OFDM signal. Such a detected phase rotation amount is inputted into the NCO 111 as a narrowband carrier frequency error. Details of the narrowband frequency error detecting circuit 110 are described later with reference to FIGS. 16 and 17.

The FFT calculation circuit 112 carries out the FFT calculation with respect to the baseband OFDM signal, so as to extract and output a signal, which is an orthogonally-modulated sub-carrier. The FFT calculation circuit 112 extracts, from one OFDM symbol, a signal corresponding to the length of the effective symbol, and carries out the FFT calculation with respect to the signal thus extracted. That is, the FFT calculation circuit 112 removes, from one OFDM symbol, a signal corresponding to the GI period, and carries out the FFT calculation with respect to the signal from which the signal corresponding to the GI period has been removed.

A range of the signal which is extracted to be subjected to the FFT calculation may be in any position in one OFDM transmission symbol, in a case where the signal is extracted continuously. A start point of the range of the signal thus extracted is in any position in the guard interval period, for example. The signal, modulated into each of the sub-carriers and extracted by the FFT calculation circuit 112, is a complex signal constituted by a real axis component (I channel signal) and an imaginary axis component (Q channel signal). The signal extracted by the FFT calculation circuit 112 is supplied to the TMCC decoding circuit 113, the broadband carrier frequency error correction circuit 114, and the waveform equalization circuit 115.

The waveform equalization circuit 115 receives, from the FFT calculation circuit 112, the signal that has been demodulated from each of the sub-carriers. Like a waveform equalization circuit described in Patent Literature 1, the waveform equalization circuit 115 includes (not illustrated though): an SP extraction circuit for extracting an SP carrier from the FFT demodulation signal; an SP generation circuit for generating an SP standard carrier; a complex division circuit for dividing the SP carrier thus extracted, by the SP standard carrier; an SP interpolation LPF; a data extraction circuit; and another complex division circuit for dividing a data carrier extracted by the data extraction circuit, by a data carrier transmission function obtained by the SP interpolation LPF. With these, the waveform equalization circuit 115 carries out carrier demodulation with respect to the FFT demodulation signal. In a case where the waveform equalization circuit 115 demodulates an OFDM signal in compliance with an ISDB-T standard, the waveform equalization circuit 115 carries out, for example, DQPSK differential demodulation, or synchronous demodulation such as QPSK, 16QAM, or 64QAM.

The TMCC decoding circuit 113 decodes transmission control information (such as the TMCC), which has been modulated to a predetermined position in an OFDM transmission frame. The error correction processing section 116 corrects an error of the OFDM signal which has been subjected to waveform equalization performed by the waveform equalization circuit 115.

The following description explains the symbol synchronous circuit 109 and the narrowband carrier frequency error detecting circuit 110, which are included in the OFDM demodulator 100, with reference to FIGS. 17 and 18.

FIG. 17 is a block diagram illustrating arrangements of both the symbol synchronous circuit 109 and the narrowband carrier frequency error detecting circuit 110. The symbol synchronous circuit 109 includes a guard correlation circuit 121, a filter 122, an amplitude finding circuit 123, and a maximum value detecting circuit 124. Further, the narrowband carrier frequency error detecting circuit 110 includes the guard correlation circuit 121, the filter 122, and a phase finding circuit 125. The guard correlation circuit 121 and the filter 122 are included in both the symbol synchronous circuit 109 and the narrowband carrier frequency error detecting circuit 110.

The guard correlation circuit 121 receives the baseband OFDM signal (like the one illustrated in (A) of FIG. 18) which is outputted from the carrier frequency error correction circuit 107. The guard correlation circuit 121 generates a guard correlation signal based on the OFDM signal thus received. Specifically, the guard correlation circuit 121 (i) generates such a delay signal (see (B) of FIG. 18) that the OFDM signal thus received is delayed by the effective symbol period Tu, and (ii) carries out complex multiplication of the OFDM signal and the delay signal. Thereby, the guard correlation circuit 121 obtains the guard correlation signal (see (C) and (D) of FIG. 18).

The filter 122 receives the guard correlation signal generated by the guard correlation circuit 121. The filter 122 filters the guard correlation signal thus received. Generally, the filter 122 carries out moving average processing with respect to the guard correlation signal thus received, for the length of the guard interval period, so as to generate the guard correlation signal thus filtered (see (E) and (F) of FIG. 18). The guard correlation signal thus filtered is a complex signal whose amplitude component has its peak precisely at a boundary position between the OFDM symbols.

The amplitude finding circuit 123 receives the guard correlation signal filtered by the filter 122. The amplitude finding circuit 123 finds an amplitude (or electric power) of each of a real number component and an imaginary number component of the guard correlation signal thus filtered, and adds amplitudes (or electric power) thus found. Thereby, the amplitude finding circuit 123 finds an amplitude component (like the one illustrated in (G) of FIG. 18). The maximum value detecting circuit 124 detects a peak position of the amplitude component found by the amplitude finding circuit 123.

(H) of FIG. 18 shows the peak position detected by the maximum value detecting circuit 124. A symbol start position is timing which is delayed by 1 sampling timing from this peak position. The maximum value detecting circuit 124 generates a symbol timing signal indicating the boundary between the symbols, and supplies the symbol timing signal thus generated, to the FFT calculation circuit 112 and the phase finding circuit 125.

The phase finding circuit 125 receives the guard correlation signal filtered by the filter 122. The phase finding circuit 125 refers to the symbol timing signal generated by the maximum value detecting circuit 122, so as to detect a phase (see (G) of FIG. 18) of the guard correlation signal at the boundary between the symbols.

Here, a phase component found by the phase finding circuit 125 is 0 if there is no deviation of the center frequency of the OFDM signal after digital orthogonal decoding is carried out. On the other hand, if there is deviation of the center frequency, the phase component is phase-rotated by an amount of such deviation. That is, the phase component found by the phase finding circuit 125 shows the amount of the deviation of the center frequency of the OFDM signal that has been subjected to the orthogonal demodulation. It should be noted that since this phase component rotates at 360° at frequency intervals of the sub-carrier, the phase component is information in an accuracy of ±1/2 or less of the frequency intervals of the sub-carrier.

By representing the amount of the deviation of the center frequency as “δFc”, and the transmission signal as “s(t)”, the received signal “r(t)” can be represented by the following Formula (1).

r(t)=s(t)·e^{j2πδF}^{_{c}}^{t} (1)

Further, the guard correlation signal generated by the guard correlation circuit 121 can be represented by the following Formula (2).

$$\begin{matrix}r ( t ) \cdot {r}^{*} ( t - {T}_{u} ) = s ( t ) \cdot {e}^{j 2 πδ {F}_{c} t} \cdot {s}^{*} ( t - {T}_{u} ) \cdot {e}^{j 2 πδ {F}_{c} ( t - {T}_{u} )} \\ = {\vert s ( t ) \vert}^{2} \cdot {e}^{- j2πδ {F}_{c} {T}_{u}} ( Tg period )\end{matrix} \qquad ( 2 )$$

Here, “X*” is a complex conjugate of “X”.

Note that “Tg period” represented in Formula (2) and in the following explanation is the guard interval period Tg (see (B) of FIG. 18) of the OFDM signal that has been delayed by the effective symbol period Tu, that is, a period (see (C) and (D) of FIG. 18) in which the guard correlation signal shows correlation of the OFDM signal. As shown by Formula (2), the guard correlation signal generated by the guard correlation circuit 121 has a constant phase “−2πδFcTu” in the Tg period. Therefore, by simply carrying out the moving average processing for the length of the guard interval period by the filter 122, for example, it is possible to obtain correlation waveforms (see (E) and (F) of FIG. 18). The phase at the peak position, indicated by (F) of FIG. 18, is a result of the moving average processing performed with respect to only the guard interval period. Accordingly, a fluctuation of the phase at the peak position is suppressed, so that it is possible to detect a phase rotation amount exp (−j2πδFc·Tu) with high accuracy by use of the narrowband carrier frequency error δFc. The phase finding circuit 125 accumulates phases thus detected, and outputs a result of the accumulation to the NCO 111, as illustrated in FIG. 16. After that, based on the frequency correction signal (complex signal) outputted from the NCO 111, the phase rotation, due to the narrowband carrier frequency error δFc detected by the carrier frequency error correction circuit 107, is corrected.

However, in a case where there is a spurious disturbing wave having a strong peak at a particular frequency in a transmission band, or another transmission signal (such as an analogue television broadcast) in the transmission band, correlation due to such a disturbing wave is added to the guard correlation signal generated by the guard correlation circuit 121. In this case, with the symbol synchronous circuit 109 or the narrowband carrier frequency error detecting circuit 110 described above, it is impossible to precisely detect the boundary between the symbols, and the narrowband carrier frequency error.

The following description explains a case where the spurious disturbing wave is mixed in the transmission with reference to FIG. 19. (A) of FIG. 19 illustrates an OFDM signal. (B) of FIG. 19 illustrates the spurious disturbing wave included in the received signal r(t). Note that in this example, the spurious disturbing wave is a sine wave represented by the following Formula (3), for the sake of simple explanation.

n(t)=A·e^{j2πF}^{ᵢ}^{t} (3)

In a case where the spurious disturbing wave represented by Formula (3) is included in the received signal r(t), the guard correlation signal generated by the guard correlation circuit 121 can be represented by the following Formula (4).

$$\begin{matrix}r ( t ) \cdot {r}^{*} ( t - {T}_{u} ) = \{ s ( t ) + n ( t ) \} {\{ s ( t - {T}_{u} ) + n ( t - {T}_{u} ) \}}^{*} \\ = s ( t ) \cdot {s}^{*} ( t - {T}_{u} ) + s ( t ) \cdot {n}^{*} ( t - {T}_{u} ) + \\ n ( t ) \cdot {s}^{*} ( t - {T}_{u} ) + n ( t ) \cdot {n}^{*} ( t - {T}_{u} )\end{matrix} \qquad ( 4 )$$

By ignoring terms that are not correlated with each other in Formula (4), the following Formula (5) can be obtained.

$$\begin{matrix}r ( t ) \cdot {r}^{*} ( t - {T}_{u} ) \approx s ( t ) \cdot {s}^{*} ( t - {T}_{u} ) + n ( t ) \cdot {n}^{*} ( t - {T}_{u} ) \\ = \{ \begin{matrix}{\vert s ( t ) \vert}^{2} \cdot {e}^{- j 2 π {F}_{c} {T}_{u}} + {A}^{2} {e}^{- j 2 π {F}_{i} {T}_{u}} ( Tg period ) \\ {A}^{2} {e}^{- j 2 π {F}_{i} {T}_{u}} ( Other than Tg period )\end{matrix}\end{matrix} \qquad ( 5 )$$

As is clear from Formula (5), correlation between the disturbing waves, which correlation has a constant correlation value, is added to the guard correlation signal generated by the guard correlation circuit 121, as illustrated in (C) and (D) of FIG. 19. Because of this, the amplitude component of the guard correlation signal which has been filtered, which amplitude component is found by the amplitude finding circuit 123, becomes a waveform like the one illustrated in (E) of FIG. 19, where the peak position is not found.

Further, in a case where the spurious disturbing wave is mixed in the transmission band, a phase rotation amount which includes: the phase rotation amount exp (−j2πδFc·Tu) due to the narrowband carrier frequency error δFc which should be detected by the narrowband carrier frequency error detecting circuit 110; and also a constant phase rotation amount exp (−j2πFi·Tu) as an offset rotation amount, is found by the phase finding circuit 125. In other words, the phase detecting circuit 125 falsely finds the phase rotation amount by an amount of Fi.

In view of the problem, Patent Literature 2 discloses a technique of (i) detecting a constant correlation value which is included, as an offset, in the guard correlation signal illustrated in (C) and (D) of FIG. 19, and (ii) removing the offset thus detected. The guard correlation signal from which the offset is removed by the technique disclosed in Patent Literature 2 will be as illustrated in (F) and (G) of FIG. 19. From the guard correlation signal from which the offset has been removed, an amplitude component like the one illustrated in (H) of FIG. 19 can be obtained. Thereby, it is possible to precisely detect the peak of the amplitude component.

Here, the constant correlation due to the spurious disturbing wave, which correlation is included in the guard correlation signal as the offset, is identical with the guard correlation signal other than the Tg period in Formula (5). Further, a sum of the constant correlation value due to the spurious disturbing wave and an original correlation value of the OFDM signal itself is identical with the guard correlation signal in the Tg period in Formula (5). Therefore, a difference obtained by subtracting the former one from the latter one is identical with the original correlation value of the OFDM signal itself. Accordingly, by calculating the narrowband carrier frequency error based on the guard correlation signal from which the offset has been removed as described above, it is possible to precisely detect the δFc without falsely detecting the phase rotation amount by the amount of Fi.

### CITATION LIST

Patent Literature 1

Japanese Patent Application Publication, Tokukai, No. 2004-214960 A (Publication Date: Jul. 29, 2004)

Patent Literature 2

Japanese Patent Application Publication, Tokukai, No. 2005-322954 A (Publication Date: Nov. 17, 2005)

Non-Patent Literature 1

“Receiver for Digital Terrestrial Sound Broadcast, Overview of ARIB Standard (ARIB STD-B30) (Desirable Specifications)”, Ver. 1.2, Association of Radio Industries and Businesses (Enactment Date: May 31, 2001) (Revision Date (Ver. 1.2): Jul. 29, 2003)

### SUMMARY OF INVENTION

However, with the conventional arrangement in which the guard correlation signal is integrated over the guard interval, it has been possible to cancel only an oscillation component whose cycle is sufficiently shorter than the guard interval, among oscillation components due to disturbing waves, which oscillation components are included in the guard correlation signal. Because of this, it has been impossible to obtain a constant offset value. For example, in a case where there are a plurality of spurious disturbing waves each of which has a strong peak at a particular frequency in the transmission band, it has been impossible to cancel the oscillating correlation between the disturbing waves that are different from each other. Because of this, it has been impossible to obtain a constant offset value. For this reason, in a case where there is such an oscillation component, guard correlation of the OFDM signal itself cannot be extracted, so that correction of the narrowband carrier frequency error, and symbol synchronization (symbol timing detection) cannot be carried out precisely.

The following description explains details of the problem described above.

Here, as an example, the following description explains a case where two spurious disturbing waves are mixed in the transmission band. In this example, a first spurious disturbing wave is a sine wave represented by the following Formula (6), and a second spurious disturbing wave is another sine wave represented by the following Formula (7), for the sake of simple explanation.

n₁(t)=A₁·e^{j2πF}^{ᵢ₁}^{t} (6)

n₂(t)=A₂·e^{j2πF}^{ᵢ₂}^{t} (7)

At this point, the guard correlation signal generated by the guard correlation circuit 121 can be represented by the following Formula (8).

$$\begin{matrix}r ( t ) \cdot {r}^{*} ( t - {T}_{u} ) = \{ s ( t ) + {n}_{1} ( t ) + {n}_{2} ( t ) \} \\ {\{ s ( t - {T}_{u} ) + {n}_{1} ( t - {T}_{u} ) + {n}_{2} ( t - {T}_{u} ) \}}^{*} \\ = s ( t ) \cdot {s}^{*} ( t - {T}_{u} ) + s ( t ) \cdot {n}_{1}^{*} ( t - {T}_{u} ) + \\ s ( t ) \cdot {n}_{2}^{*} ( t - {T}_{u} ) + {n}_{1} ( t ) \cdot {s}^{*} ( t - {T}_{u} ) + \\ {n}_{1} ( t ) \cdot {n}_{1}^{*} ( t - {T}_{u} ) + {n}_{1} ( t ) \cdot {n}_{2}^{*} ( t - {T}_{u} ) + \\ {n}_{2} ( t ) \cdot {s}^{*} ( t - {T}_{u} ) + {n}_{2} ( t ) \cdot {n}_{1}^{*} ( t - {T}_{u} ) + \\ {n}_{2} ( t ) \cdot {n}_{2}^{*} ( t - {T}_{u} )\end{matrix} \qquad ( 8 )$$

By ignoring terms that are not correlated with each other in Formula (8), the following Formula (9) can be obtained.

$$r ( t ) \cdot {r}^{*} ( t - {T}_{u} ) = s ( t ) \cdot {s}^{*} ( t - {T}_{u} ) + {n}_{1} ( t ) \cdot {n}_{1}^{*} ( t - {T}_{u} ) + {n}_{2} ( t ) \cdot {n}_{2}^{*} ( t - {T}_{u} ) + {n}_{1} ( t ) \cdot {n}_{2}^{*} ( t - {T}_{u} ) + {n}_{2} ( t ) \cdot {n}_{1}^{*} ( t - {T}_{u} ) \approx \{ \begin{matrix}{\vert s ( t ) \vert}^{2} \cdot {e}^{- j2π {F}_{c} {T}_{u}} + {A}_{1}^{2} {e}^{- j 2 π {F}_{i 1} {T}_{u}} + {A}_{2}^{2} {e}^{- j2π {F}_{i 2} {T}_{u}} + \\ {A}_{1} \cdot {A}_{2} \cdot {e}^{- j 2 π ( {F}_{i 1} t - {F}_{i 2} ( t - {T}_{u} ) )} + {A}_{1} \cdot {A}_{2} \cdot {e}^{- j 2 π ( {F}_{i 2} t - {F}_{i 1} ( t - {T}_{u} ) )} ( Tg period ) \\ {A}_{1}^{2} {e}^{- j 2 π {F}_{i 1} {T}_{u}} + {A}_{2}^{2} {e}^{- j 2 π {F}_{i 2} {T}_{u}} + \\ {A}_{1} \cdot {A}_{2} \cdot {e}^{- j 2 π ( {F}_{i 1} t - {F}_{i 2} ( t - {T}_{u} ) )} + {A}_{1} \cdot {A}_{2} \cdot {e}^{- j 2 π \{ {F}_{i 2} t - {F}_{i 1} ( t - {T}_{u} ) \}} \\ ( Other than Tg period )\end{matrix} \qquad ( 9 )$$

As represented by Formula (9), the guard correlation signal calculated by the guard correlation circuit 121 includes: constant correlation (a second term, and a third term of “Tg period”, and a first term and a second term of “other than Tg period”) between disturbing waves that are identical with each other; and also oscillating correlation (a fourth term and a fifth term of “Tg period”, and a third term and fourth term of “other than Tg period”) between disturbing waves that are different from each other.

Therefore, even the moving average of the guard interval period Tg is obtained by the filter 122, the guard correlation signal that has been subjected to the moving average processing has an offset, and at the same time, oscillates, as illustrated in (C) and (D) of FIG. 20. Accordingly, an amplitude component (illustrated in (E) of FIG. 20) found by the amplitude finding circuit 123 does not have the peak at the boundary between the transmission symbols. Further, (F) and (G) of FIG. 20 illustrate the guard correlation signal from which the constant correlation between the identical disturbing waves has been removed. As illustrated in (F) and (G) of FIG. 20, after the constant correlation between the identical disturbing waves is removed from the guard correlation signal, an oscillation component still remains, and the correlation of the OFDM signal itself is buried. (H) of FIG. 20 is a sum of an amplitude of (F) of FIG. 20 and an amplitude of (G) of FIG. 20. It can be seen that, in (H) of FIG. 20, peaks other than the guard interval period Tg are found. Therefore, it is difficult to detect the boundary between the transmission symbols.

Next, the following description deals with detection of the narrowband carrier frequency error with reference to FIG. 21.

In a case where there is no spurious disturbing wave in the transmission band, the narrowband carrier frequency error detecting circuit 110 detects a target amount δFc of the deviation of the center frequency of the OFDM signal which has been subjected to the orthogonal demodulation, as a result of the narrowband carrier frequency error detection, as illustrated in (A) of FIG. 21. On the other hand, in a case where a single spurious disturbing wave represented by Formula (3) is mixed in the transmission band, the narrowband carrier frequency error detecting circuit 110 detects the δFc to which δFi, which is a phase of the spurious disturbing wave, is added, as illustrated in (B) of FIG. 21. Note that the δFi is a constant value, and can be removed by the technique disclosed in Patent Literature 2. However, in a case where two spurious disturbing waves are mixed in the transmission band, even if the symbol start position is found, and the guard interval period Tg is found, a detected value of the narrowband carrier frequency error oscillates due to correlation between the two spurious disturbing waves, as illustrated in (C) of FIG. 21. In the case where the detected value oscillates as described above, it becomes impossible to sufficiently remove the correlation between the disturbing waves by the technique disclosed in Patent Literature 2.

The present invention is made in view of the problem. An object of the present invention is to realize an OFDM demodulator which, even in a case where correlation due to disturbing waves is not constant, (i) can cancel an oscillation component due to the disturbing waves, which oscillation component is included in a guard correlation signal, and (ii) can precisely carry out correction of a narrowband carrier frequency error, and symbol synchronization.

In order to attain the object, an OFDM demodulator of the present invention, for demodulating a first OFDM signal whose transmission unit is a transmission symbol including an effective symbol and a guard interval to which a part of a signal waveform of the effective symbol is copied, includes: symbol number direction integration means for integrating, in a symbol number direction, a first correlation value between the first OFDM signal and a second OFDM signal that is obtained by delaying the first OFDM signal by an effective symbol period, by accumulating the first correlation value every transmission symbol period, so as to find a second correlation value; offset removal means for removing an offset from the second correlation value, the offset being estimated based on the second correlation value; and symbol timing generating means for generating symbol timing indicating a boundary between the transmission symbols based on the second correlation value from which the offset is removed.

With the arrangement, even if the correlation value between the first OFDM signal and the second OFDM signal that is obtained by delaying the first OFDM signal by the effective symbol period includes an oscillation component due to disturbing waves, the symbol number direction integration means integrates the correlation value in the symbol number direction, so as to cancel the oscillation component. That is, the correlation value integrated in the symbol number direction includes a correlation value of the OFDM signal itself, and a constant offset due to the disturbing waves. The offset removal means removes the offset from the correlation value integrated in the symbol number direction. Therefore, the correlation value which is integrated and from which the offset is removed is the correlation value of the OFDM signal itself. For this reason, the symbol timing generating means can generate, based on the correlation value which is integrated and from which value the offset is removed, the symbol timing that precisely indicates the boundary between the transmission symbols. That is, the OFDM demodulator can precisely carry out the symbol synchronization.

In order to attain the object, an OFDM demodulation method of the present invention, for demodulating a first OFDM signal whose transmission unit is a transmission symbol including an effective symbol and a guard interval to which a part of a signal waveform of the effective symbol is copied, includes the steps of: integrating, in a symbol number direction, a first correlation value between the first OFDM signal and a second OFDM signal that is obtained by delaying the first OFDM signal by an effective symbol period, by accumulating the first correlation value every transmission symbol period, so as to find a second correlation value; removing an offset from the second correlation value, the offset being estimated based on the second correlation value; and generating symbol timing indicating a boundary between the transmission symbols based on the second correlation value from which the offset is removed.

With the arrangement, even if the correlation value between the first OFDM signal and the second OFDM signal that is obtained by delaying the first OFDM signal by the effective symbol period includes an oscillation component due to disturbing waves, the symbol number direction integration means integrates the correlation value in the symbol number direction, so as to cancel the oscillation component. That is, the correlation value integrated in the symbol number direction includes a correlation value of the OFDM signal itself, and a constant offset due to the disturbing waves. The offset removal means removes the offset from the correlation value integrated in the symbol number direction. Therefore, the correlation value which is integrated and from which the offset is removed is the correlation value of the OFDM signal itself. For this reason, in the step of generating the symbol timing, based on the correlation value which is integrated and from which value the offset is removed, it is possible to generate the symbol timing that precisely indicates the boundary between the transmission symbols. That is, the OFDM demodulator can precisely carry out the symbol synchronization.

In order to attain the object, an OFDM demodulator of the present invention, for demodulating a first OFDM signal whose transmission unit is a transmission symbol including an effective symbol and a guard interval to which a part of a signal waveform of the effective symbol is copied, includes: symbol number direction integration means for integrating, in a symbol number direction, a first correlation value between the first OFDM signal and a second OFDM signal that is obtained by delaying the first OFDM signal by an effective symbol period, by accumulating the first correlation value every transmission symbol period, so as to find a second correlation value; offset removal means for removing an offset from the second correlation value, the offset being estimated based on the second correlation value; and error detecting means for detecting a narrowband carrier frequency error based on the second correlation value from which the offset is removed.

With the arrangement, even if the correlation value between the first OFDM signal and the second OFDM signal that is obtained by delaying the first OFDM signal by the effective symbol period includes an oscillation component due to disturbing waves, the symbol number direction integration means integrates the correlation value in the symbol number direction, so as to cancel the oscillation component. That is, the correlation value integrated in the symbol number direction includes a correlation value of the OFDM signal itself, and a constant offset due to the disturbing waves. The offset removal means removes the offset from the correlation value integrated in the symbol number direction. Therefore, the correlation value which is integrated and from which the offset is removed is the correlation value of the OFDM signal itself. For this reason, the narrowband carrier frequency error correction means can precisely detect the narrowband carrier frequency error, based on the correlation value of the OFDM signal itself.

In order to attain the object, an OFDM demodulation method of the present invention, for demodulating a first OFDM signal whose transmission unit is a transmission symbol including an effective symbol and a guard interval to which a part of a signal waveform of the effective symbol is copied, comprising the steps of: integrating, in a symbol number direction, a first correlation value between the first OFDM signal and a second OFDM signal that is obtained by delaying the first OFDM signal by an effective symbol period, by accumulating the first correlation value every transmission symbol period, so as to find a second correlation value; removing an offset from the second correlation value, the offset being estimated based on the second correlation value; and detecting a narrowband carrier frequency error based on the second correlation value from which the offset is removed.

With the arrangement, even if the correlation value between the first OFDM signal and the second OFDM signal that is obtained by delaying the first OFDM signal by the effective symbol period includes an oscillation component due to disturbing waves, the symbol number direction integration means integrates the correlation value in the symbol number direction, so as to cancel the oscillation component. That is, the correlation value integrated in the symbol number direction includes a correlation value of the OFDM signal itself, and a constant offset due to the disturbing waves. The offset removal means removes the offset from the correlation value integrated in the symbol number direction. Therefore, the correlation value which is integrated and from which the offset is removed is the correlation value of the OFDM signal itself. For this reason, in the step of correcting the narrowband carrier frequency error, it is possible to precisely detect the narrowband carrier frequency error, based on the correlation value of the OFDM signal itself.

The OFDM demodulator of the present invention preferably further includes stability determination means for (i) determining a stability of the phase rotation amount detected by the phase rotation amount detecting means, and (ii) determining, in accordance with the stability thus determined, how many transmission symbol periods are used by the symbol number direction integration means to accumulate the first correlation value.

With the arrangement, the number of the transmission symbol periods used to accumulate the correlation value is determined by the stability determination means, and the symbol number direction integration means only has to accumulate the correlation value for predetermined transmission symbol periods. Accordingly, the correlation value does not continue to increase endlessly as time elapses. Therefore, it is possible to prevent a decrease in a response of the symbol number direction integration means.

The OFDM demodulator of the present invention preferably further includes stability determination means for (i) determining a stability of the phase rotation amount detected by the phase rotation amount detecting means, and (ii) resetting, in accordance with the stability thus determined, a sum obtained by accumulating the correlation value every transmission symbol period, the sum being stored in the symbol number direction integration means.

With the arrangement, the symbol number direction integration means only has to continue accumulating the correlation value until the stability determination means resets the sum. Accordingly, the correlation value does not continue to increase endlessly as time elapses. Therefore, it is possible to prevent a decrease in a response of the symbol number direction integration means.

In the OFDM demodulator of the present invention, the stability determination means may determine the stability of the phase rotation amount by comparing a predetermined threshold value with a difference between a maximum value and a minimum value of the phase rotation amount within a certain period.

Further, in the OFDM demodulator of the present invention, the stability determination means may determine the stability of the phase rotation amount by comparing a predetermined threshold value with a variance of the phase rotation amount within a certain period.

Note that the OFDM demodulator can be realized by a computer. In this case, the scope of the present invention encompasses an OFDM demodulation program for realizing the OFDM demodulator by causing the computer to function as each means described above, and a storage medium in which the program is stored.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a block diagram of an arrangement of a main part of an OFDM demodulator, in accordance with First Embodiment of the present invention.

FIG. 2 is a timing chart of each signal used in narrowband carrier frequency error correction processing, in a case where a plurality of spurious disturbing waves are mixed in a transmission band, in accordance with First Embodiment of the present invention.

FIG. 3 is a block diagram of an internal arrangement of a symbol integration circuit, in accordance with First Embodiment of the present invention.

FIG. 4 is a timing chart of each signal used in symbol interval integration processing, in the case where the plurality of spurious disturbing waves are mixed in the transmission band, in accordance with First Embodiment of the present invention.

FIG. 5 is a block diagram of an internal arrangement of an offset removal circuit, in accordance with First Embodiment of the present invention.

FIG. 6 is a block diagram of an arrangement of a main part of an OFDM demodulator, in accordance with Second Embodiment of the present invention.

FIG. 7 is a block diagram of an internal arrangement of the symbol integration circuit, in accordance with Second Embodiment of the present invention.

FIG. 8 is a block diagram of an internal arrangement of the offset removal circuit, in accordance with Second Embodiment of the present invention.

FIG. 9 is a block diagram of an internal arrangement of a stability determination circuit, in accordance with Second Embodiment of the present invention.

FIG. 10 is a block diagram of an internal arrangement of the stability determination circuit, in accordance with Third Embodiment of the present invention.

FIG. 11 is a block diagram of an internal arrangement of the symbol integration circuit, in accordance with Third Embodiment of the present invention.

FIG. 12 is a block diagram of an internal arrangement of the offset removal circuit, in accordance with Third Embodiment of the present invention.

FIG. 13 is a block diagram of an internal arrangement of the stability determination circuit, in accordance with Fourth Embodiment of the present invention.

FIG. 14 is a block diagram of an internal arrangement of the stability determination circuit, in accordance with Fifth Embodiment of the present invention.

FIG. 15 is a view illustrating an arrangement of a transmission symbol of an OFDM signal.

FIG. 16 is a block diagram illustrating an arrangement of a conventional OFDM demodulator.

FIG. 17 is a block diagram illustrating arrangements of: a circuit for carrying out narrowband carrier frequency error correction processing; a circuit for carrying out broadband carrier frequency error correction processing; and a circuit for detecting symbol timing, each of which is included in the conventional OFDM demodulator.

FIG. 18 is a timing chart of each signal used in conventional narrowband frequency error correction processing.

FIG. 19 is a timing chart of each signal used in the conventional narrowband carrier frequency correction processing, in a case where a spurious disturbing wave is mixed in a transmission band.

FIG. 20 is a timing chart of each signal used in the conventional narrowband carrier frequency error correction processing, in a case where a plurality of spurious disturbing waves are mixed in the transmission band.

FIG. 21 is view showing a narrowband carrier frequency error detected in the conventional narrowband carrier frequency error correction processing, in accordance with a sort of disturbing wave in the transmission band.

### REFERENCE SIGNS LIST

109. SYMBOL SYNCHRONOUS CIRCUIT
110. NARROWBAND CARRIER FREQUENCY ERROR DETECTING CIRCUIT
121. GUARD CORRELATION CIRCUIT
131. SYMBOL INTEGRATION CIRCUIT
132. OFFSET REMOVAL CIRCUIT
122. FILTER
123. AMPLITUDE FINDING CIRCUIT
124. MAXIMUM VALUE DETECTING CIRCUIT
125. PHASE FINDING CIRCUIT
107. CARRIER FREQUENCY ERROR CORRECTION CIRCUIT
111. NCO
112. FFT CALCULATION CIRCUIT
114. BROADBAND CARRIER FREQUENCY CORRECTION CIRCUIT

### DESCRIPTION OF EMBODIMENTS

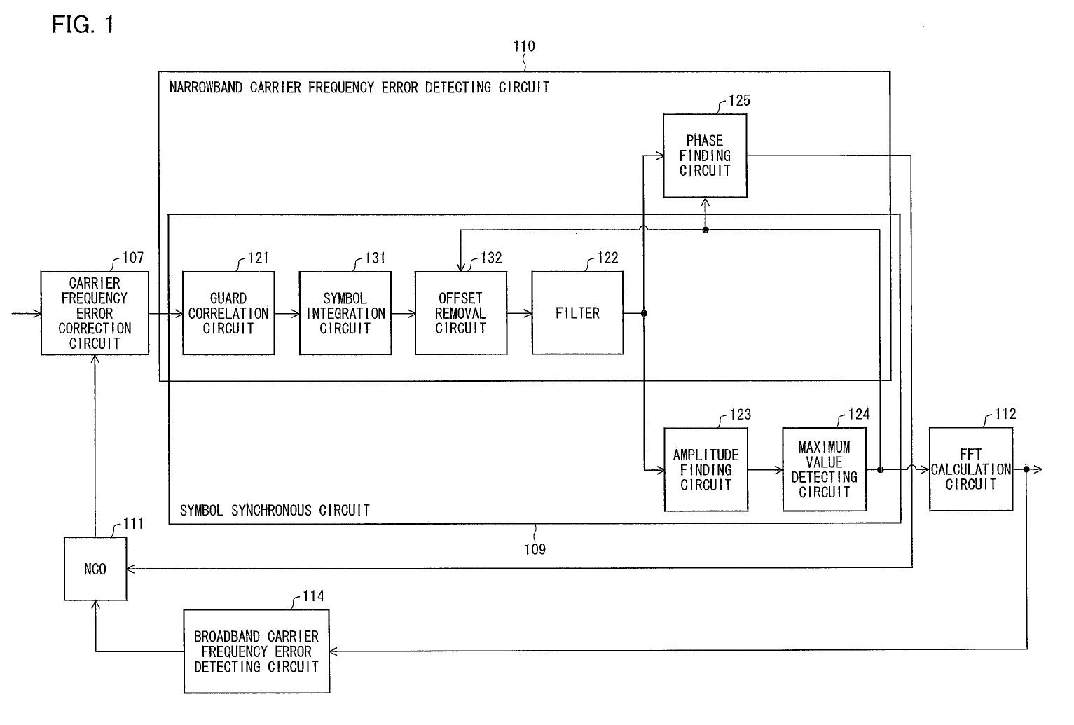

Embodiments of the present invention are described below with reference to FIGS. 1 through 14.

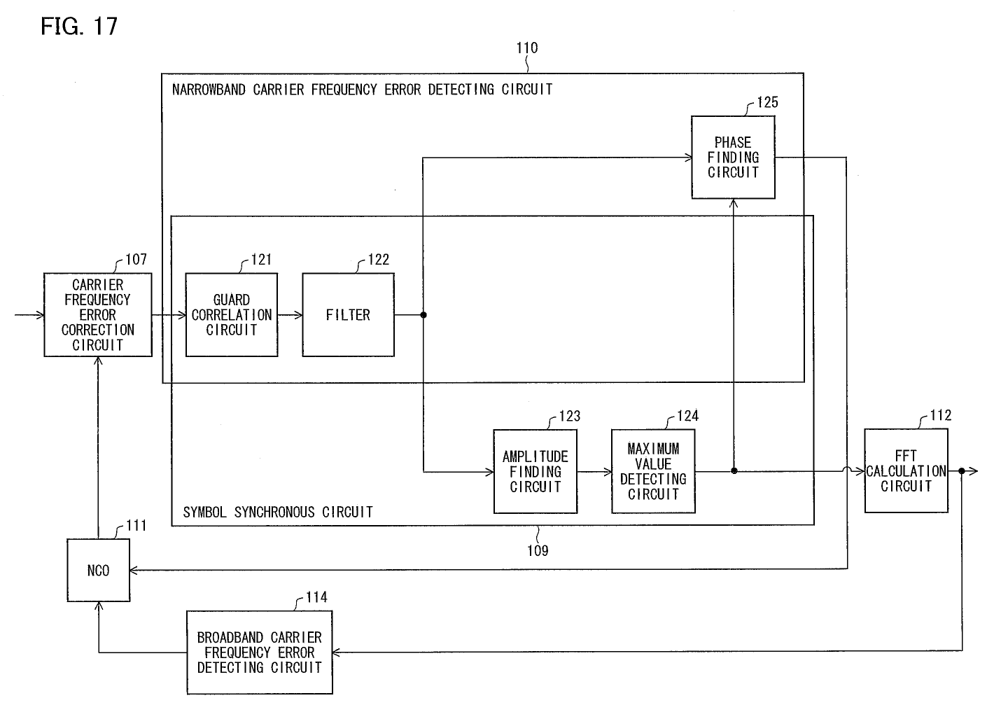

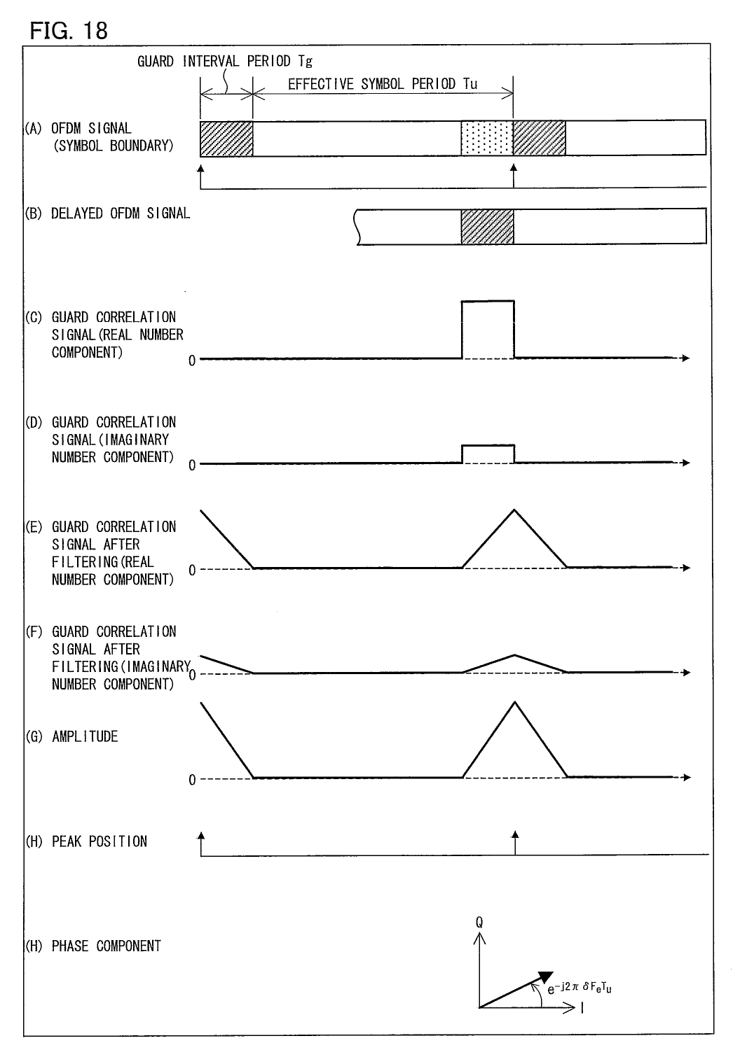

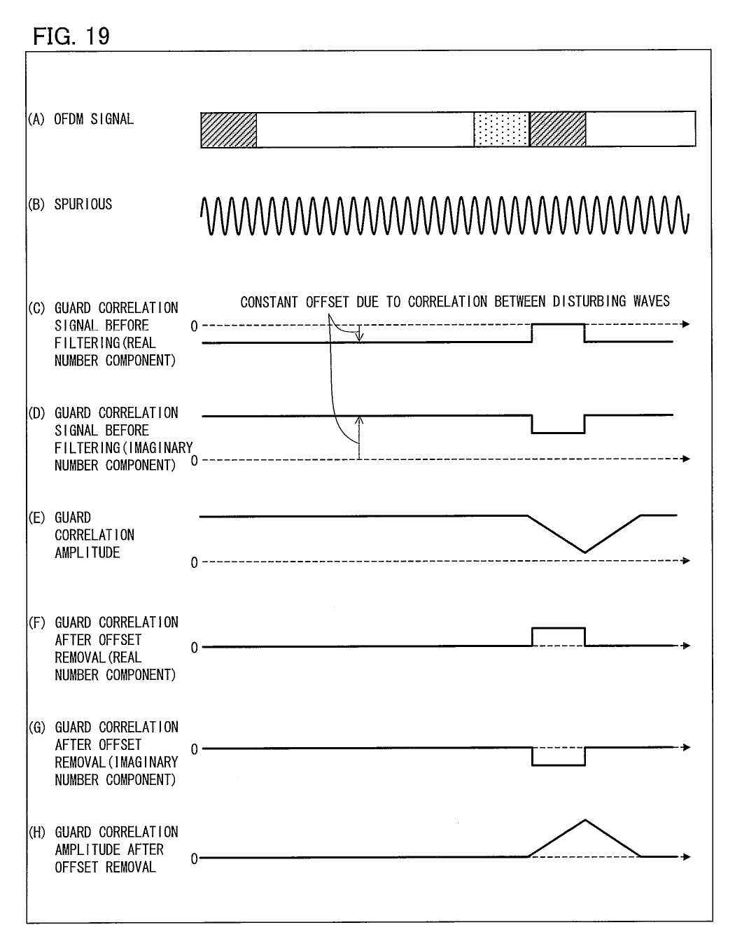

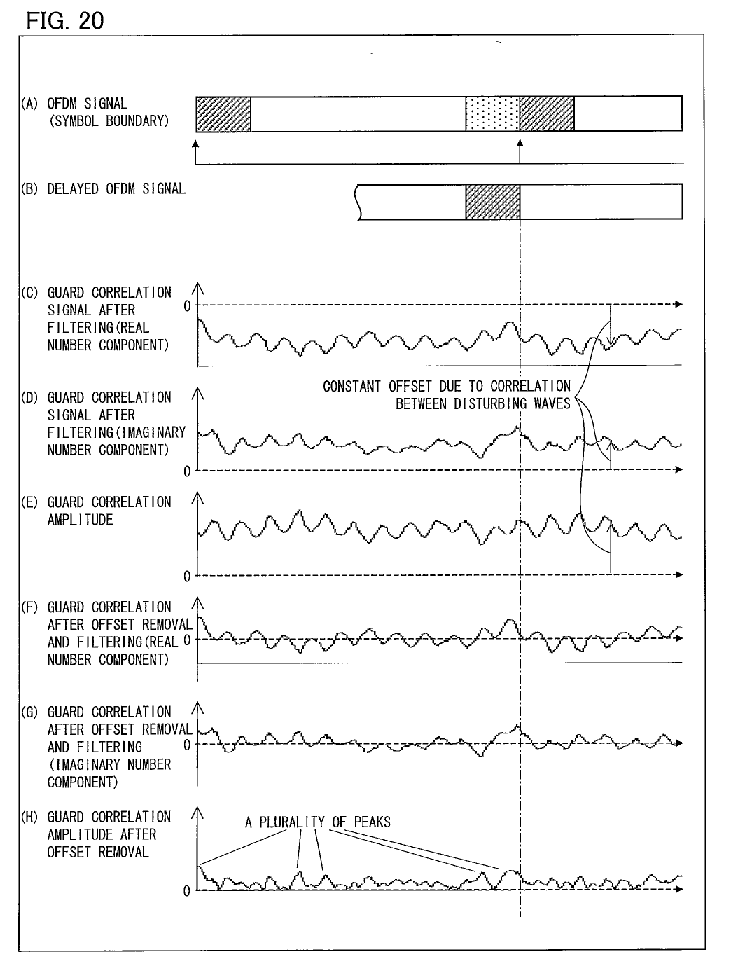

Note that an OFDM (Orthogonal Frequency Division Multiplexing) demodulator in accordance with each of the embodiments described below can schematically have an arrangement similar to a conventional OFDM demodulator illustrated in FIG. 17, and its main feature resides in a symbol synchronous circuit and a narrowband carrier frequency error detecting circuit. For this reason, the following description explains the symbol synchronous circuit and the narrowband carrier frequency error detecting circuit, which are included in the OFDM demodulator in accordance with each of the embodiments.

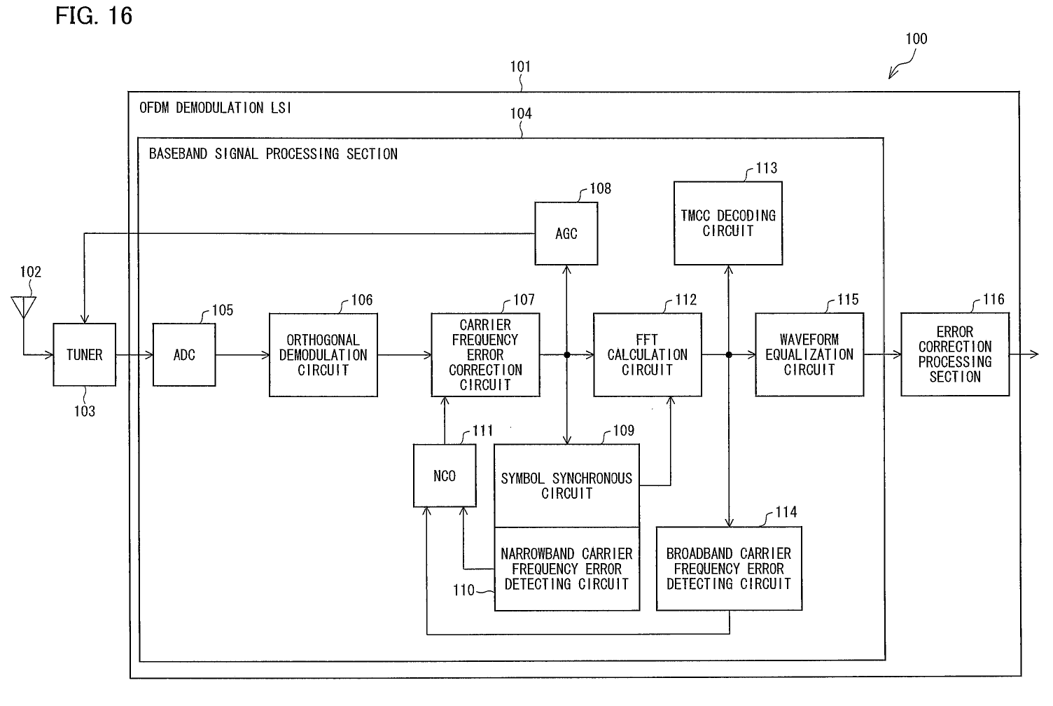

Note that the OFDM demodulator in accordance with each of the embodiments has an arrangement similar to a conventional OFDM demodulator illustrated in FIG. 16, except for the symbol synchronous circuit and the narrowband carrier frequency error detecting circuit. As such, the following description omits explanations of such an arrangement here. Note however that since the OFDM demodulator of the present invention is not limited to these, the scope of the present invention encompasses another OFDM demodulator obtained by appropriately modifying arrangements other than the symbol synchronous circuit and the narrowband carrier frequency error detecting circuit.

### First Embodiment

An OFDM demodulator of First Embodiment of the present invention is described below with reference to FIGS. 1 through 5.

FIG. 1 is a block diagram illustrating how a symbol synchronous circuit 109 and a narrowband carrier frequency error detecting circuit 110 are arranged, which are included in the OFDM demodulator of the present embodiment.

First, the symbol synchronous circuit 109 of the present embodiment is described below with reference to FIG. 1.

The symbol synchronous circuit 109 of the present embodiment includes a guard correlation circuit 121, a symbol integration circuit 131, an offset removal circuit 132, a filter 122, an amplitude finding circuit 123, and a maximum value detecting circuit 124 (see FIG. 1).

The guard correlation circuit 121 receives a baseband OFDM signal outputted from a carrier frequency error correction circuit 107. The guard correlation circuit 121 is means for generating a guard correlation signal in accordance with the OFDM signal thus received. Specifically, the guard correlation circuit 121 obtains the guard correlation signal by, for example, (i) causing the OFDM signal thus received to be delayed by an effective symbol period so as to generate a delay signal, and (ii) carrying out complex multiplication of the OFDM signal thus received and the delay signal thus generated.

The symbol integration circuit 131 receives the guard correlation signal generated by the guard correlation circuit 121. The symbol integration circuit 131 is means for carrying out symbol interval integration with respect to the guard correlation signal thus received. Here, the symbol interval integration is accumulation of a guard correlation signal, which accumulation is carried out every transmission symbol period. That is, the symbol interval integration is integration of the guard correlation signal in a symbol number direction, which guard correlation signal can be represented as a function of time and symbol number. The symbol integration circuit 131 constitutes the main feature of the present invention, so that details of the symbol integration circuit 131 are specifically described later with reference to separate drawings.

The offset removal circuit 132 receives the guard correlation signal which has been subjected to the symbol interval integration made by the symbol integration circuit 131. The offset removal circuit 132 is means for removing a correlation value between disturbing waves, which value is included, as an offset, in the guard correlation signal which has been subjected to the symbol interval integration. Details of the offset removal circuit 132 are also described later with reference to a separate drawing.

The filter 122 receives the guard correlation signal from which the offset has been removed by the offset removal circuit 132. The filter 122 is means for carrying out predetermined filtering with respect to the guard correlation signal from which the offset has been removed. The predetermined filtering encompasses moving average processing performed with respect to the guard correlation signal thus received, for example.

The amplitude finding circuit 123 receives the guard correlation signal which has been filtered by the filter 122. The amplitude finding circuit 123 is means for finding an amplitude of the guard correlation signal thus filtered. Specifically, the amplitude finding circuit 123 obtains an amplitude of the guard correlation signal thus filtered, for example, by (i) finding amplitudes (or electric powers) of real and imaginary number components of the guard correlation signal thus filtered, and (ii) adding the amplitudes (or the electric powers). The amplitude of the guard correlation signal filtered by the filter 122 has its peak precisely at a boundary between transmission symbols.

The maximum value detecting circuit 124 receives the amplitude of the guard correlation signal thus filtered, which amplitude is found by the amplitude finding circuit 123. The maximum value detecting circuit 124 is means for generating a symbol timing signal indicating the boundary between the transmission symbols, in response to the amplitude of the guard correlation signal thus filtered. The maximum value detecting circuit 124 supplies the symbol timing signal thus generated, to an FFT calculation circuit 112, a phase finding circuit 125, and the offset removal circuit 132.

Next, the following description explains the narrowband carrier frequency error detecting circuit 110 of the present embodiment, with reference to FIG. 1.

The narrowband carrier frequency error detecting circuit 110 of the present embodiment includes the phase finding circuit 125 in addition to the guard correlation circuit 121, the symbol integration circuit 131, the offset removal circuit 132, and the filter 122, each of which is described above.

The phase finding circuit 125 receives the guard correlation signal that has been subjected to (i) the symbol interval integration by the symbol integration circuit 131, (ii) the offset removal by the offset removal circuit 132 and (iii) the filtering by the filter 122. Further, the phase finding circuit 125 receives the symbol timing signal generated by the maximum value detecting circuit 124. The phase finding circuit 125 finds a narrowband carrier frequency error by (i) detecting, based on the symbol timing signal, phases of the guard correlation signal thus received which phases are at a boundary between respective transmission symbols and (ii) accumulating the phases thus detected.

A broadband carrier frequency error detecting circuit 114 (i) extracts a pilot signal from each sub-carrier which has been subjected to FFT calculation and (ii) detects a broadband carrier frequency error in frequency interval accuracy of the sub-carrier in response to the pilot signal thus extracted. An NCO 111 finds a frequency correction signal, which is a complex signal, based on (i) the broadband carrier frequency error detected by the broadband carrier frequency error detecting circuit 114 and (ii) the narrowband carrier frequency error detected by the narrowband carrier frequency error detecting circuit 110. The carrier frequency error correction circuit 107 carries out complex multiplication with respect to the frequency correction signal calculated by the NCO 111, so as to correct deviation of a center frequency of the OFDM signal which has been subjected to orthogonal demodulation.

In a case where there is, in the transmission band, a strong spurious disturbing wave and/or another transmission signal such as an analogue television broadcast, the guard correlation signal includes an oscillation component due to such a disturbing wave. Even in such a case, the arrangement of the symbol synchronous circuit 109 illustrated in FIG. 1 makes it possible to precisely detect a boundary between transmission symbols in response to the guard correlation signal which has been subjected to the symbol interval integration. Further, with the arrangement of the narrowband carrier frequency error detecting circuit 110 illustrated in FIG. 1, it is possible to precisely detect an amount of the deviation of the center frequency of the OFDM signal which has been subjected to the orthogonal demodulation.

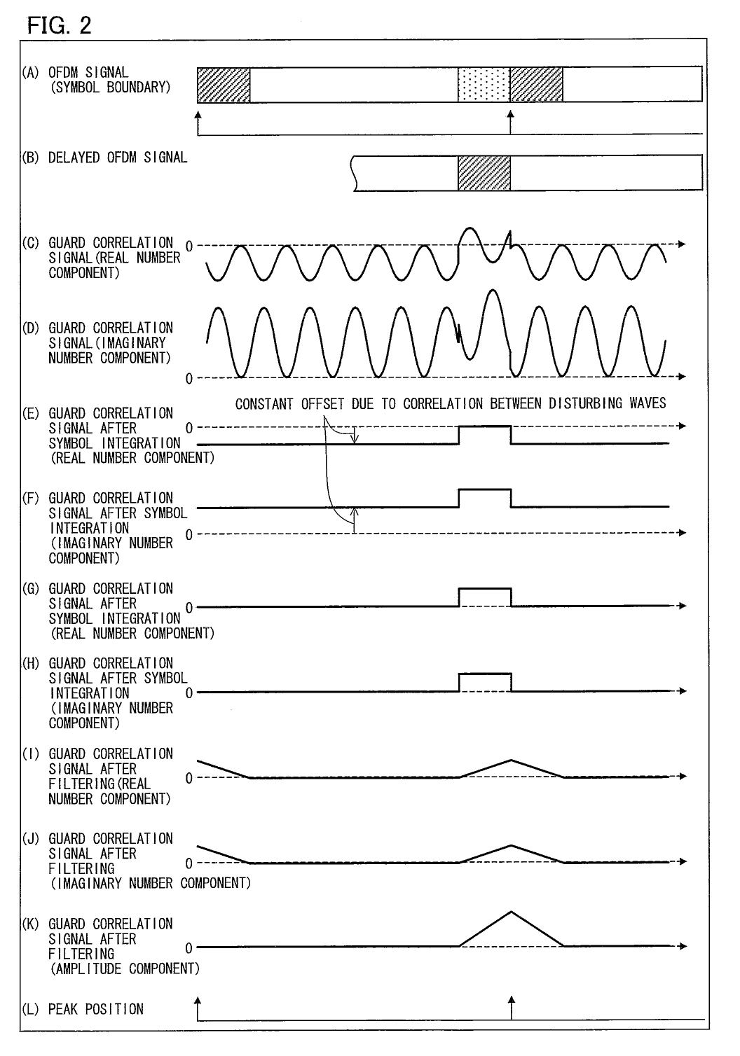

The following description explains such effects more specifically with reference to FIG. 2. The description deals with an example in which two spurious disturbing waves “n1(t)” and “n2(t)”, which are represented by Formula (6) and Formula (7) respectively, are included in a received signal “r(t)”.

As described above, the guard correlation signal found by the guard correlation circuit 121 includes: a constant correlation (a second term and a third term of “Tg period”, and a first term and a second term of “other than Tg period”) between disturbing waves that are identical with each other; and an oscillating correlation (a fourth term and a fifth term of “Tg period”, and a third term and a fourth term of “other than Tg period”) between disturbing waves that are different from each other, as represented by Formula 9. That is, the guard correlation signal found by the guard correlation circuit 121 has the offset, and oscillates, as illustrated in (C) and (D) of FIG. 2.

Note that, as represented by the following Formula (10), the oscillating correlation between the disturbing waves that are different from each other can be cancelled by integration over a time interval that is sufficiently longer than an oscillation cycle |Fᵢ₁−Fᵢ₂|.

$${\sum }_{k = 1}^{L} {A}_{1} \cdot {A}_{2} \cdot {e}^{- j 2 π \{ {F}_{i 2} {T}_{u} + ( {F}_{i 1} - {F}_{i 2} ) k \}} + {\sum }_{k = 1}^{L} {A}_{1} \cdot {A}_{2} \cdot {e}^{- j2π \{ {F}_{i 1} {T}_{u} + ( {F}_{i 2} - {F}_{i 1} ) k \}} \approx 0 \\ ( L >> \vert {F}_{i 1} - {F}_{i 2} \vert ) \qquad ( 10 )$$

However. in a case where the guard correlation signal represented by Formula (9) is integrated in a time axis direction, there occurs a problem that a peak can no longer be found in an integration value when an integration interval becomes substantially as large as Ts.

In view of the problem, the symbol integration circuit 131 of the present invention integrates, in the symbol number direction, the guard correlation signal represented by Formula 9. In a case where the guard correlation signal is integrated in the symbol number direction over a sufficient period, the oscillating correlation between the disturbing waves that are different from each other is cancelled, as represented by the following Formula (11).

ΣA₁·A₂·e^{-j2π{F}^{ᵢ₂}^{T}^{ᵤ}^{+(F}^{ᵢ₁}^{-F}^{ᵢ₂}^{)kT}^{₂}^{}}+ΣA₁·A₂·e^{-j2π{F}^{ᵢ₁}^{T}^{ₑ}^{+(F}^{ᵢ₂}^{-F}^{ᵢ₁}^{)kT}^{ₛ}^{}}≈0 (11)

Further, the symbol interval integration is such that the value of the guard correlation signal is accumulated every transmission symbol period. It follows that data in a guard interval period is added to data in a guard interval period of another symbol all the time. The correlation value of the OFDM signal itself is substantially constant in Tg periods of the respective transmission symbols. As such, the guard correlation signal that has been subjected to the symbol interval integration is equal to the addition of the constant correlation between the disturbing waves and the correlation of the OFDM signal itself, as illustrated in (E) and (F) of FIG. 2.

The offset removal circuit 132 receives the guard correlation signal, having a constant offset, which is illustrated in (E) and (F) of FIG. 2. This causes the offset removal circuit 132 to completely remove the constant offset due to the correlation between the disturbing waves, thereby allowing the correlation value of the OFDM signal itself to be obtained (see (G) and (H) of FIG. 2). Accordingly, the guard correlation signal filtered by the filter 122 becomes as illustrated in (I) and (J) of FIG. 2, and the amplitude found by the amplitude finding circuit 123 becomes as illustrated in (K) of FIG. 2. That is, the peak of the amplitude found by the amplitude finding circuit 123 precisely coincides with the boundary between the transmission symbols. Therefore, the maximum value detecting circuit 124 can precisely detect the boundary between the transmission symbols by detecting the peak of the amplitude found by the amplitude finding circuit 123.

The guard correlation signal from which the offset has been removed by the offset removal circuit 132 includes no correlation value between the disturbing waves. For this reason, the phase finding circuit 125 can precisely detect an amount SF of the deviation of the center frequency of the OFDM signal that has been subjected to the orthogonal demodulation, by detecting the phase of the guard correlation signal thus filtered, which phase is at the boundary between the transmission symbols.

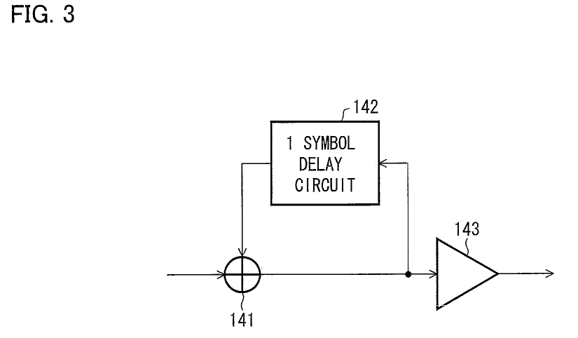

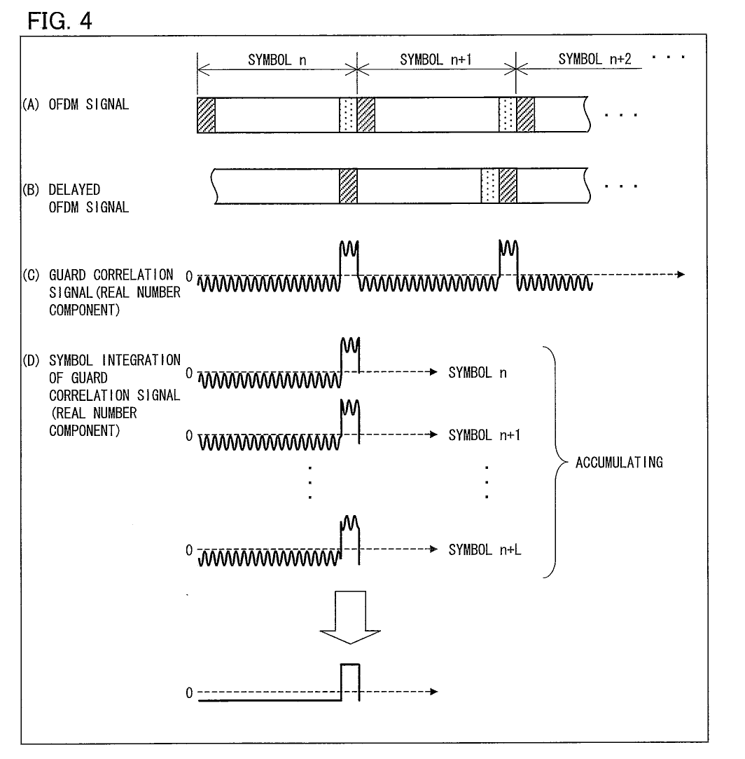

Next, the following description explains the symbol integration circuit 131 included in the symbol synchronous circuit 109 more specifically, with reference to FIGS. 3 and 4.

FIG. 3 is a block diagram illustrating an example of an arrangement of the symbol integration circuit 131. The symbol integration circuit 131 illustrated in FIG. 3 includes an adder circuit 141, a delay circuit 142, and a multiplication circuit (gain) 143.

At time t, the adder circuit 141 (i) adds an output D(t) of the delay circuit 142 to the guard correlation signal of “C(t)=r(t)r(t−Tu)” generated by the guard correlation circuit 121 and (ii) supplies a sum of “C(t)+D(t)” to the delay circuit 142 and the multiplication circuit 143. The delay circuit 142 delays the sum of “C(t)+D(t)” outputted from the adder circuit 141 by 1 transmission symbol period Ts, and outputs the sum thus delayed to the adder circuit 141. That is, the delay circuit 142 outputs “D(t)=C(t−Ts)+D(t−Ts)” at the time t. The multiplication circuit 143 multiplies the sum of “C(t)+D(t)” outputted from the adder circuit 141, by a predetermined coefficient (a constant number or a variable number) α, and then supplies a product of “α[C(t)+D(t)]” to the offset removal circuit 132.

With the arrangement of the symbol integration circuit 131 illustrated in FIG. 3, at the time of “t=s+kTs(0<s<Ts)”, the sum of “C(t)+D(t)”, outputted from the adder circuit 141, is identical with the sum of “C(s)+C(s+Ts)+C(s+2Ts)+ . . . S(s+kTs)”, which is the sum obtained by accumulating the guard correlation signal every transmission symbol period Ts. That is, the sum of “C(t)+D(t)”, outputted from the adder circuit 141, is identical with a value obtained by the integration of the guard correlation signal in the symbol number direction by regarding the guard correlation signal C(t) as a function of “C(s,k)=C(s+kTs)” (a function of a time “s” and a symbol number “k”).

The multiplication circuit 143 multiplies the sum of “C(t)+D(t)”, outputted from the adder circuit 141, by a coefficient of “α=1/(k+1)”, for example. For example, at a time of “t=s+4Ts”, the multiplication circuit 143 multiplies the sum of “C(t)+D(t)=C(s)+C(s+Ts)+C(s+2Ts)+C(s+3Ts)+C(s+4Ts)”, outputted from the adder circuit 141, by a coefficient of 1/5. This causes the product of “α[C(t)+D(t)]”, outputted from the multiplication circuit 143, to be identical with such a value that the guard correlation signal is averaged every transmission symbol period Ts.

(A) of FIG. 4 illustrates an nth transmission symbol, an (n+1)th transmission symbol, and an (n+2)th transmission symbol of the OFDM signal. Further, (B) of FIG. 4 illustrates the OFDM signal that has been delayed by an effective symbol period Tu. Furthermore, (C) of FIG. 4 illustrates a real number component of the guard correlation signal shown in a case where two spurious disturbing waves are mixed in the transmission band.

As illustrated in (D) of FIG. 4, the symbol integration circuit 131 integrates, in the symbol number direction, the guard correlation signal illustrated in (C) of FIG. 4. (D) of FIG. 4 illustrates an example where the guard correlation signal is integrated by L transmission symbols in the symbol number direction. Here, by causing the L to be sufficiently large, the integration value can be obtained as illustrated in (E) of FIG. 4. This allows cancellation of the oscillating correlation between the disturbing waves that are different from each other.

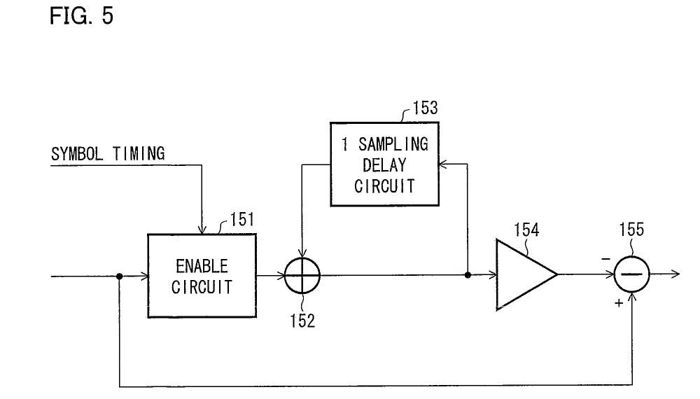

Finally, the following description explains the offset removal circuit 132 included in the symbol synchronous circuit 109 more specifically, with reference to FIG. 5.

FIG. 5 is a block diagram illustrating an example of an arrangement of the offset removal circuit 132. The offset removal circuit 132 illustrated in FIG. 5 includes an enable circuit 151, an adder circuit 152, a delay circuit 153, a multiplication circuit 154, and a subtraction circuit 155.

The enable circuit 151 receives the guard correlation signal that has been subjected to the symbol interval integration performed by the symbol integration circuit 131, and the symbol timing signal generated by the maximum value detecting circuit 124. The enable circuit 151 estimates the guard interval period Tg based on the symbol timing signal thus received, and outputs only a signal, other than the guard interval period Tg, out of the guard correlation signal that has been subjected to the symbol interval integration.

The adder circuit 152 adds an output signal of the enable circuit 151 to an output signal of the delay circuit 153, and outputs the sum thus obtained to the delay circuit 153 and the multiplication circuit 154. The delay circuit 153 delays, by 1 sampling timing, the sum outputted from the adder circuit 153, and then outputs the sum thus delayed to the adder circuit 153. The multiplication circuit 154 multiplies the sum, outputted from the adder circuit 152, by a predetermined coefficient (a constant number or a variable number), and then outputs a product, obtained from the multiplication, to the subtraction circuit 155. The subtraction circuit 155 subtracts the product (i.e. an offset value), found by the multiplication circuit 154, from the guard correlation signal that has been subjected to the symbol integration performed by the symbol integration circuit 131, and then outputs the difference thus subtracted to the filter 122.

With the arrangement of the offset removal circuit 132 illustrated in FIG. 3, the output of the multiplication circuit 154 is identical with the correlation value between the disturbing waves, which correlation value is included, as an offset, in the guard correlation signal that has been subjected to the symbol interval integration. Accordingly, the output of the subtraction circuit 155 becomes equal to a result obtained by removing the offset value from the guard correlation signal that has been subjected to the symbol interval integration.

### Second Embodiment

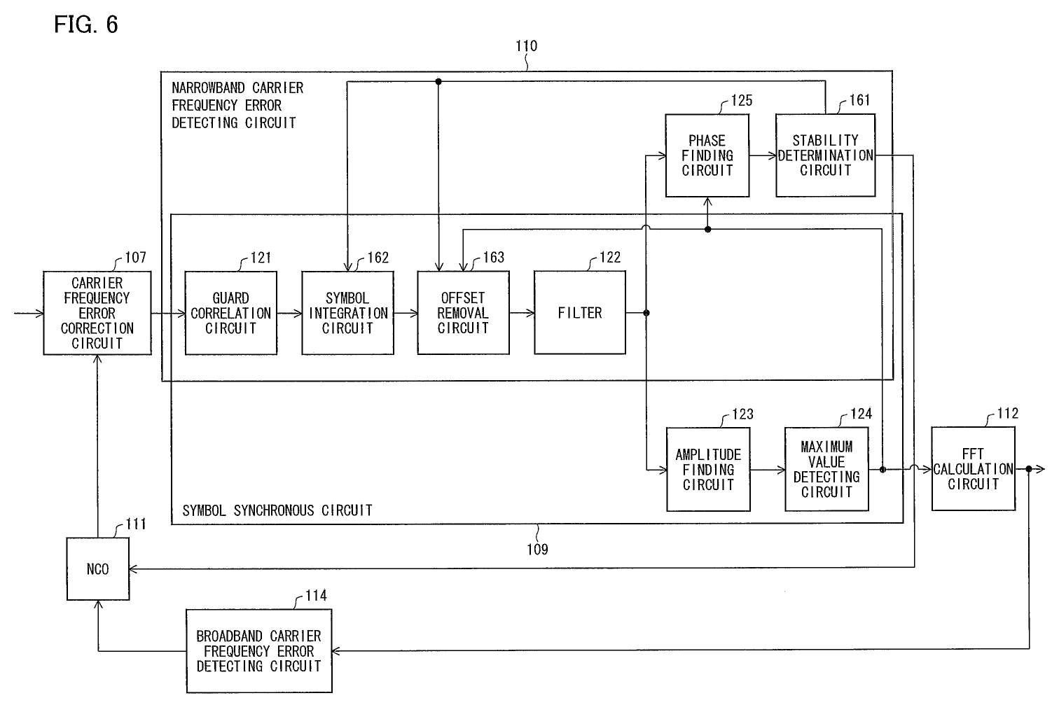

Second Embodiment of the present invention is described below with reference to FIGS. 6 through 9.

In First Embodiment, the integration is carried out by the symbol integration circuit 131 having the arrangement illustrated in FIG. 3, and by the offset removal circuit 132 having the arrangement illustrated in FIG. 5. In this case, there occurs a problem that a response will become worse gradually as previous data is accumulated.

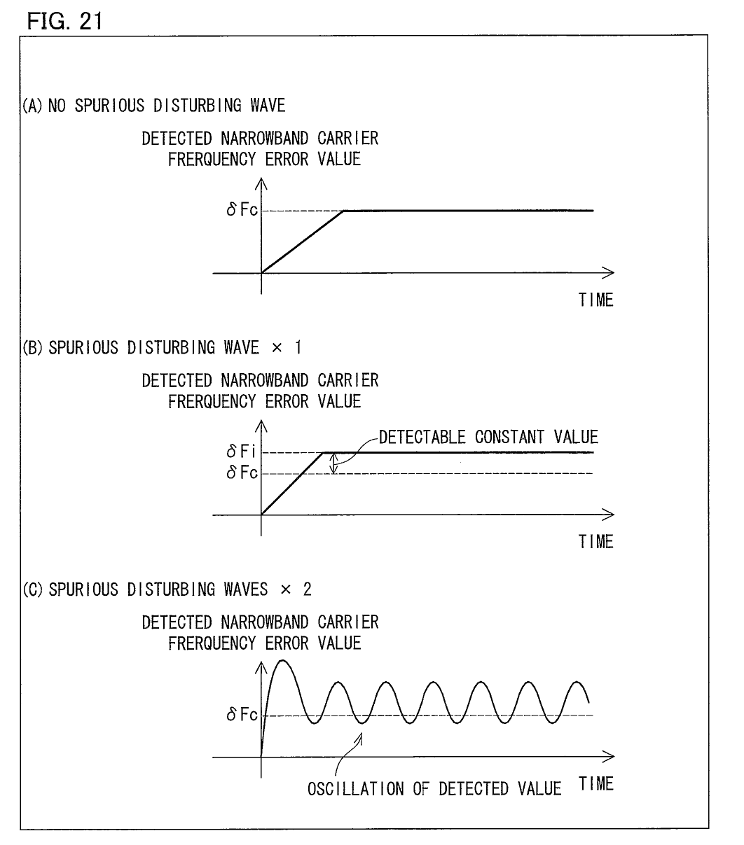

Further, an object of the integration in the symbol integration circuit is to remove non-constant correlation between the disturbing waves that are different from each other. In other words, the object is to remove, by the integration, the oscillating correlation, as represented by the fourth and fifth terms of the guard correlation of “Tg period”, and the third and fourth terms of “other than Tg period” in Formula (9). In a case where such oscillating correlation remains, a value detected by a narrowband carrier frequency error detecting circuit 110 also oscillates, as illustrated in (C) of FIG. 21. This causes a problem.

In view of the problem, an OFDM demodulator of the present embodiment introduces an arrangement for (i) determining a stability of the value detected by the narrowband carrier frequency error detecting circuit 110 and (ii) controlling a response of each of the symbol integration circuit and the offset removal circuit.

FIG. 6 is a block diagram illustrating how a symbol synchronous circuit 109 and the narrowband carrier frequency error detecting circuit 110 are arranged, which are included in the OFDM demodulator of the present embodiment.

As illustrated in FIG. 6, the narrowband carrier frequency error detecting circuit 110 includes a stability determination circuit 161, in addition to the arrangement illustrated in FIG. 1. Note that an internal arrangement of the symbol integration circuit 162 and an internal arrangement of an offset removal circuit 163 are modified as described below.

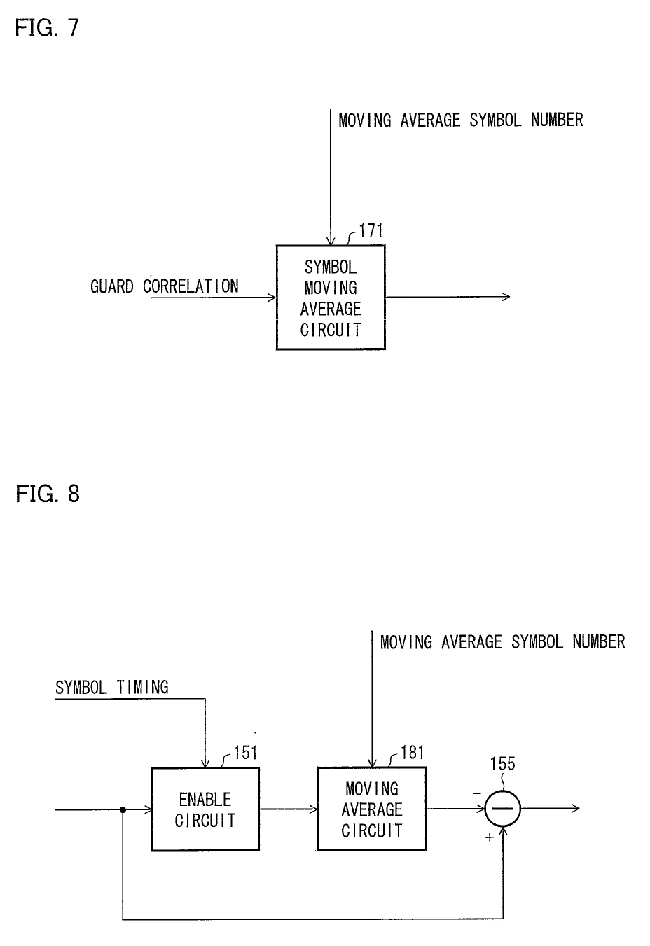

FIG. 7 is a block diagram illustrating an example of an arrangement of the symbol integration circuit 162 of the present embodiment. As illustrated in FIG. 7, the symbol integration circuit 162 of the present embodiment includes a moving average circuit 171.

The moving average circuit 171 performs moving average processing with respect to a value of a guard correlation signal generated by a guard correlation circuit 121, every transmission symbol period. An output A(t) of the moving average circuit 171, which output A(t) has been subjected to the moving average processing, can be represented by the following Formula (12), where “n” is a symbol number, “C(t)” is the guard correlation signal thus received, “Ls” is a transmission symbol number (hereinafter, referred to as “moving average symbol number”) which is the number of transmission symbols that are subjected to the moving average processing, and “Ts” is 1 transmission symbol period. Note that the moving average symbol number Ls is given by the stability determination circuit 161, as described later.

$$A ( t ) = {\sum }_{k = 0}^{Ls - 1} ( \frac{C ( t - {kT}_{s} )}{Ls} ) \qquad ( 12 )$$

FIG. 8 is a block diagram illustrating an example of an arrangement of the offset removal circuit 163 of the present embodiment. As illustrated in FIG. 8, the offset removal circuit 163 of the present embodiment includes an enable circuit 151, a moving average circuit 181, and a subtraction circuit 155.

The enable circuit 151 receives a guard correlation signal that has been subjected to symbol interval integration by a symbol integration circuit 131, and a symbol timing signal generated by a maximum value detecting circuit 124. The enable circuit 151 estimates a guard interval period Tg based on the symbol timing signal, and outputs, to the moving average circuit 181, only a signal other than the guard interval period Tg, out of the guard correlation signal that has been subjected to the symbol interval integration.

The moving average circuit 181 finds a moving average of outputs of the enable circuit 151, and then outputs the moving average to the subtraction circuit 155. The moving average circuit 181 simply finds a moving average of inputs. As such, the number of sampled points for the moving average is equal to a multiplication of (i) the moving average symbol number inputted from the stability determination circuit 161 and (ii) the sampling number per 1 transmission symbol”. The subtraction circuit 155 subtracts the output of the moving average circuit 181 from the output of the symbol integration circuit 162, and then outputs a difference thus subtracted to the filter 122.

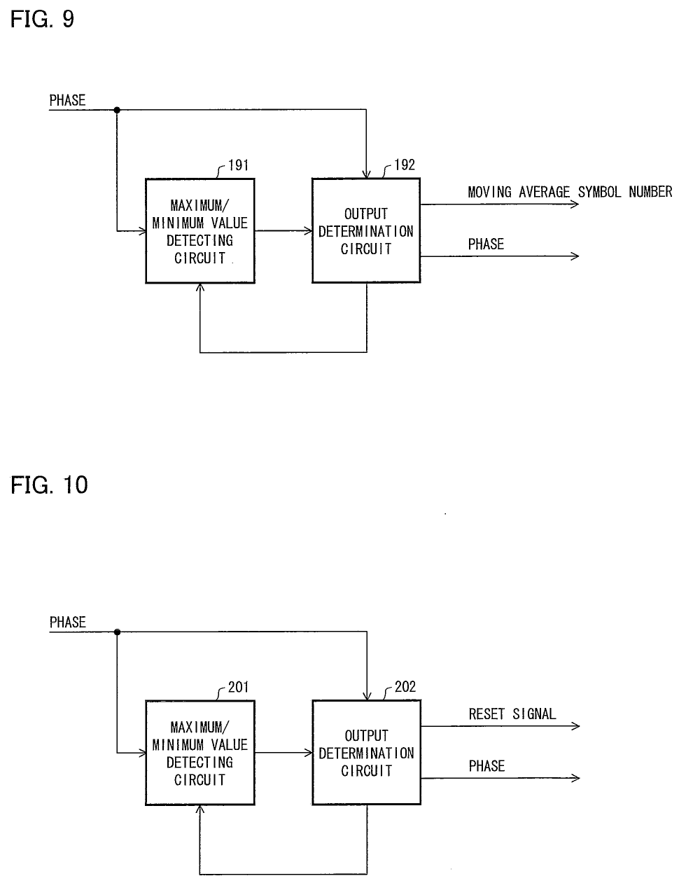

FIG. 9 illustrates an example of an arrangement of the stability determination circuit 161 of the present embodiment. As illustrated in FIG. 9, the stability determination circuit 161 of the present embodiment includes a maximum/minimum value detecting circuit 191 and an output determination circuit 192.

The maximum/minimum value detecting circuit 191 of the stability determination circuit 161 receives a phase found by a phase finding circuit 125. The maximum/minimum value detecting circuit 191 monitors the phase for a certain period, and detects a maximum value θmax and a minimum value θmin of the phase thus received during the monitoring period.

The output determination circuit 192 receives the maximum value θmax and the minimum value θmin, both of which are detected by the maximum/minimum value detecting circuit 191. The output determination circuit 192 compares (θmax−θmin) with a predetermined threshold value. If the (θmax−θmin) is not more than the predetermined threshold value, then the output determination circuit 192 (i) outputs [(θmax−θmin)/2+θmin] to an NCO 111 and (ii) outputs, as a new moving average symbol number, to the symbol integration circuit 161 and the offset removal circuit 163, a moving average symbol number that is smaller than a current moving average symbol number. On the other hand, in a case where the (θmax−θmin) is larger than the predetermined threshold value, the output determination circuit 192 (i) outputs “(θmax−θmin)/2+θmin” to the NCO 111, and (ii) outputs, as the new moving average symbol number, to the symbol integration circuit 161 and the offset removal circuit 163, a moving average symbol number that is larger than the current moving average symbol number. Further, the output determination circuit 192 resets, for every monitoring period, the maximum value and the minimum value which are detected by the maximum/minimum value detecting circuit 191.

With the arrangement described above, it becomes possible to improve the response while realizing sufficient accuracy of the narrowband carrier frequency error detection.

### Third Embodiment

Third Embodiment of the present invention is described below with reference to FIGS. 10 through 12.

In Second Embodiment, (i) each of the symbol integration circuit 162 and the offset removal circuit 163 carries out the moving average processing and (ii) the stability determination circuit 161 controls the moving average symbol number in each of the symbol integration circuit 162 and the offset removal circuit 163. This allows an improvement in response of narrowband carrier frequency error detection. However, in a case where the moving average processing is carried out by use of a circuit, there will cause a problem that a large storage region should be secured.

In view of the problem, the present embodiment modifies the internal arrangement of each of the symbol integration circuit 162, the symbol circuit offset removal circuit 163, and the stability determination circuit 161 in the narrowband carrier frequency error detection circuit 110 illustrated in FIG. 5 as follows. This allowed an improvement in response of the narrowband carrier frequency error detection.

FIG. 10 is a block diagram illustrating an arrangement of the stability determination circuit 161 of the present embodiment. As illustrated in FIG. 10, the stability determination circuit 161 of the present embodiment includes a maximum/minimum value detecting circuit 201 and an output determination circuit 202.

The maximum/minimum value detection circuit 201 of the stability determination circuit 161 receives a phase found by a phase finding circuit 125. The maximum/minimum value detection circuit 201 monitors the phase thus received for a certain period, and detects a maximum value θmax and a minimum value θmin of the phase thus received during the monitoring period.

The output determination circuit 202 receives the maximum value θmax and the minimum value θmin, both of which are detected by the maximum/minimum value detecting circuit 201. The output determination circuit 202 compares “θmax−θmin” with a predetermined threshold value. If “θmax−θmin” is not more than the predetermined threshold value, the output determination circuit 202 (i) outputs “(θmax−θmin)/2+min” to an NCO 111, (ii) resets the maximum/minimum value detecting circuit 201, and (iii) transmits a reset instruction, as a reset signal, to the symbol integration circuit 162 and the offset removal circuit 163. On the other hand, if “θmax−θmin” is larger than the predetermined threshold value, the output determination circuit 202 (i) outputs “(θmax−θmin)/2+min” to the NCO 111, (ii) resets the maximum/minimum detecting circuit 201, and (iii) transmits the reset instruction, as the reset signal, to the symbol integration circuit 162 and the offset removal circuit 163.

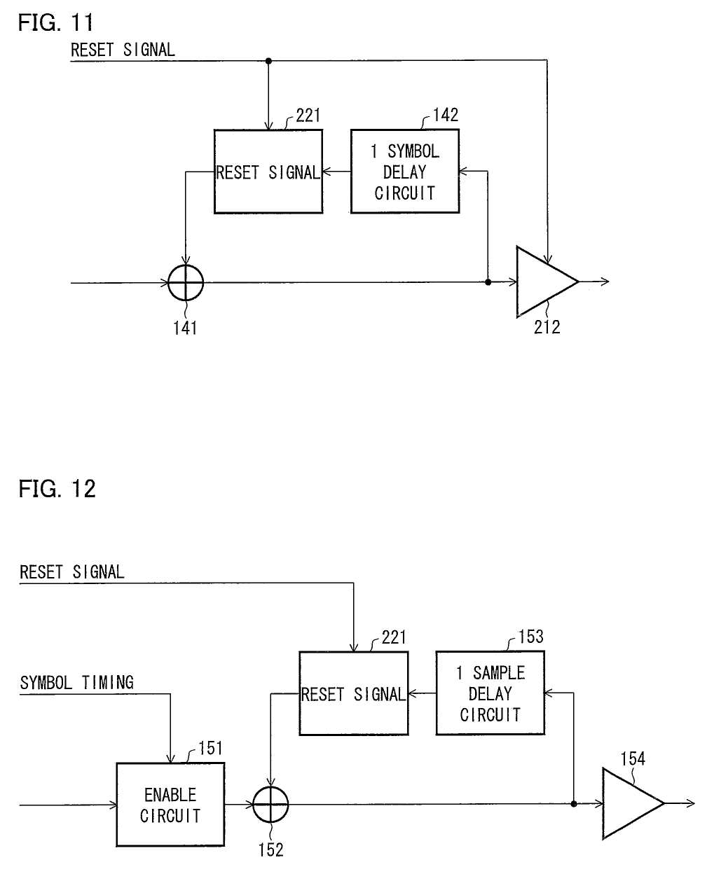

FIG. 11 is a block diagram illustrating an arrangement of the symbol integration circuit 162 of the present embodiment. As illustrated in FIG. 11, the symbol integration circuit 162 of the present embodiment includes an adder circuit 141, a delay circuit 142, a reset circuit 211, and a multiplication circuit (gain) 212.

The adder circuit 141 carries out addition of an output of the reset circuit 211 and a guard correlation signal generated by a guard correlation circuit 121, and then outputs a sum thus obtained to the gain 212. The delay circuit 142 delays the output of the adder circuit 141 by 1 transmission symbol period. The reset circuit 211 receives the output of the delay circuit 142, and a reset signal outputted from a stability determination circuit 161. In a case where the reset circuit 211 receives a reset instruction via the reset signal, the reset circuit 211 outputs zero during 1 transmission symbol period. In other cases, the reset circuit 211 outputs the output of the delay circuit 142 to the adder circuit 141 without any change. This makes it possible to reset previous data.

The multiplication circuit 212 receives the sum outputted from the adder circuit 141, and the reset signal outputted from the stability determination circuit 161. The multiplication circuit 212 multiplies the sum outputted from the adder circuit 141 by a predetermined coefficient (a constant number or a variable number). The coefficient of the multiplication circuit 212 is set, for example, to be an inverse number of the symbol number (for example, in a case where an input of a symbol integration circuit 131 is the fifth symbol, the constant number will be 1/5). Here, in a case where the multiplication circuit 212 receives the reset signal indicating the reset instruction, the multiplication circuit 212 resets the symbol number back to “1”. After that, the symbol number again increases by “1”, every transmission symbol period. In response to this, the coefficient of the multiplication circuit 212 changes to be 1, 1/2, 1/3 . . . 1/n every transmission symbol period.

FIG. 12 is a block diagram illustrating an arrangement of an offset removal circuit 132 of the present embodiment. As illustrated in FIG. 12, the offset removal circuit 132 of the present embodiment includes an enable circuit 151, an adder circuit 152, a delay circuit 153, a multiplication circuit (gain) 154, and a reset circuit 221.

The enable circuit 151 receives a guard correlation signal that has been subjected to symbol interval integration carried out by the symbol integration circuit 131, and a symbol timing signal generated by a maximum value detecting circuit 124. The enable circuit 151 estimates a guard interval period Tg based on the symbol timing signal thus received, and outputs, to the adder circuit 152, only a signal other than the guard interval period Tg out of the guard correlation signal that has been subjected to the symbol interval integration.

The adder circuit 152 carries out addition of the output of the enable circuit 151 and the output of the reset circuit 221, and outputs a sum thus obtained to the multiplication circuit 154 and the delay circuit 153. The delay circuit 153 delays the sum calculated by the adder circuit 152, by 1 sampling timing, and outputs the sum thus delayed, to the adder circuit 152 via the reset circuit 221. In a case where the reset circuit 221 receives the reset signal indicating the reset instruction, the reset circuit 221 outputs “0” to the adder circuit 152. In other cases, the reset circuit 221 outputs the output of the delay circuit 153 to the adder circuit 152 without any change. The multiplication circuit 154 multiplies the sum outputted from the adder circuit 152, by a predetermined coefficient (a constant number or a variable number), and outputs a product thus obtained, to the subtraction circuit 155. The subtraction circuit 155 subtracts the product calculated by the multiplication circuit 154, from the guard correlation signal that has been subjected to the symbol integration performed by the symbol multiplication circuit 131, and outputs a difference thus subtracted, to the filter 122.

With the arrangement, since the method of resetting the integration value is employed, it is possible to reduce a necessary storage region, as compared with Second Embodiment. Further, it is possible to improve the response, as compared with First Embodiment.

### Fourth Embodiment

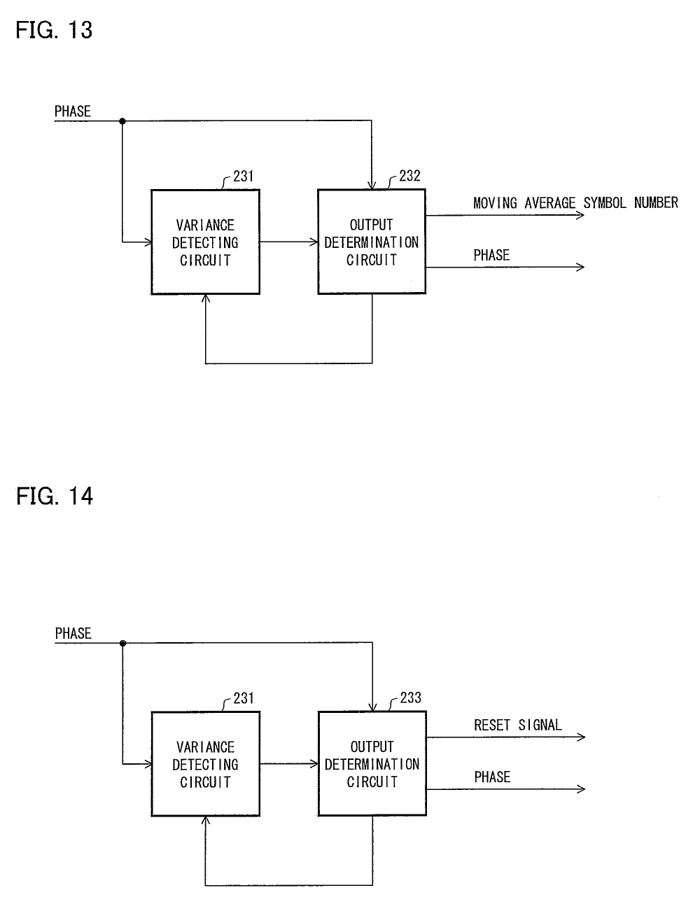

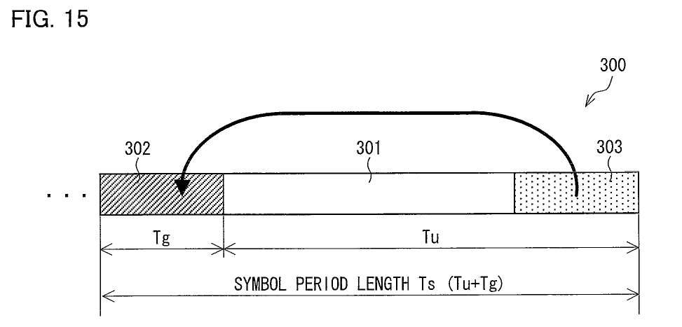

Fourth Embodiment of the present invention is described below with reference to FIG. 13.

The stability detecting circuit 161 (see FIG. 9) of Second Embodiment may be arranged to (i) simply calculate a variance of an input, and (ii) compare the variance thus calculated, with a predetermined threshold value.

FIG. 13 is a block diagram illustrating an arrangement of a stability detecting circuit 161 of the present embodiment. As illustrated in FIG. 13, the stability determination circuit 161 of the present embodiment includes a variance detecting circuit 231 and an output determination circuit 232.

The variance detecting circuit 231 receives a phase found by a phase finding circuit 125. The variance detecting circuit 231 detects a variance of an input phase within a detecting period Td, and outputs the variance thus detected to the output determination circuit 232. The output determination circuit 232 determines a moving average symbol number based on the variance detected by the variance detecting circuit 231, and outputs the moving average symbol number to the symbol integration circuit 162 and an offset removal circuit 163.

Note that the stability determination circuit 161 may output the phase received from the phase finding circuit 125, to an NCO 111 without any change, or may output the phase after filtering the phase in the period Td (by use of an FIR filter or an IIR filter).

### Fifth Embodiment

Fifth Embodiment of the present invention is described below with reference to FIG. 14.

The stability detecting circuit 161 (see FIG. 10) of Third Embodiment may (i) simply calculate a variance of an input, and (ii) compare the variance thus calculated, with a predetermined threshold value.

FIG. 14 is a block diagram illustrating an arrangement of a stability determination circuit 161 of the present embodiment. As illustrated in FIG. 14, the stability determination circuit 161 of the present embodiment includes a variance detecting circuit 231 and an output determination circuit 233.

The variance detecting circuit 231 receives a phase found by a phase finding circuit 125. The variance detecting circuit 231 detects a variance of an input phase within a detecting period Td, and outputs the variance thus detected to the output determination circuit 233. The output determination circuit 233 compares a predetermined threshold value with the variance detected by the variance detecting circuit 231. If the variance is smaller than the threshold value, the output determination circuit 233 outputs a reset signal to a symbol integration circuit 162 and an offset removal circuit 163. At this point, the phase outputted to an NCO 111 is a phase inputted from the phase finding circuit 125 immediately before the reset signal is transmitted.

[Additional Matters]

The present invention is not limited to the description of the embodiments above, but may be altered by a skilled person within the scope of the claims. An embodiment based on a proper combination of technical means disclosed in different embodiments is encompassed in the technical scope of the present invention.

In each of the embodiments described above, an NCO 111 generates a sine wave, and a carrier frequency error correction circuit 107 including a complex multiplier carries out phase correction. However, the present invention is not limited to this, and it is possible to constitute an OFDM demodulator by replacing the NCO 111 and the carrier frequency error correction circuit 107 with a CORDIC (Coordinate Rotation Digital Computer) circuit described in “VLSI Algorithm of Arithmetical Operation (Naohumi TAKAGI, CORONA Publishing Co., Ltd., 2005)”. This circuit is such a circuit that in a case where a complex signal “Z=I+jQ” and a phase θ are inputted into the circuit, the circuit outputs “Zexp(jθ)”. As long as the method of carrying out phase rotation processing is employed, the present invention is not limited to each of the embodiments described above.

Further, the OFDM demodulator of the present invention may be arranged as described below.

An OFDM demodulator of the present invention, for demodulating an OFDM signal whose transmission unit is a transmission symbol including an effective symbol and a guard interval to which a part of a signal waveform of the effective symbol is copied, may include: carrier frequency error correction means for correcting an amount of deviation of a center frequency of the OFDM signal, and outputting a correction OFDM signal; complex correlation calculation means for calculating a complex correlation value between the correction OFDM signal and a delay correction OFDM signal that is inputted before by a length of an effective symbol period; means for integrating the complex correlation value at symbol intervals; offset removal means for estimating, based on the complex correlation value that has been integrated at the symbol intervals, an amount of an offset of correlation due to identical channel interference, and removing the amount of the offset from the complex correlation value; means for carrying out guard interval integration with respect to the complex correlation value from which the offset has been removed; means for finding an amplitude component that indicates a strength of a value obtained by the guard interval integration; and means for estimating, based on the amplitude component, a boundary between the transmission symbols, and generating symbol timing.

An OFDM demodulator of the present invention, for demodulating an OFDM signal whose transmission unit is a transmission symbol including an effective symbol and a guard interval to which a part of a signal waveform of the effective symbol is copied, may include: carrier frequency error correction means for correcting an amount of deviation of a center frequency of the OFDM signal, and outputting a correction OFDM signal; complex correlation calculation means for calculating a complex correlation value between the correction OFDM signal and a delay correction OFDM signal that is inputted before by a length of an effective symbol period; means for integrating the complex correlation value at symbol intervals; offset removal means for estimating, based on the complex correlation value that has been integrated at the symbol intervals, an amount of an offset of correlation due to identical channel interference, and removing the amount of the offset from the complex correlation value; means for carrying out guard interval integration with respect to the complex correlation value from which the offset has been removed; means for determining, based on a value obtained by the guard interval integration, a phase rotation amount during 1 effective symbol period, and detecting a narrowband carrier frequency error.

The OFDM demodulator of the present invention may further include means for detecting a stability of the narrowband carrier frequency error thus detected, and means for dynamically changing, based on the stability thus detected, the number of integration points of said means for carrying out the integration at the symbol intervals.

The OFDM demodulator of the present invention may further include means for detecting a stability of the narrowband carrier frequency error thus detected, and means for resetting, based on the stability thus detected, an integration value of said means for performing the integration at symbol intervals.

In the OFDM demodulator of the present invention, the means for detecting the stability may detect the stability based on a maximum value and a minimum value of the amount of the phase rotation within a certain period.

In the OFDM demodulator of the present invention, the means for detecting the stability may detect the stability based on a variance of the amount of the phase rotation within a certain period.

Lastly, each block of the OFDM demodulator of each of the embodiments may be constituted by hardware logic as described above, or may be realized by software by use of a CPU as described below.

That is, the OFDM demodulator includes: a CPU (central processing unit) which executes an instruction of a program realizing each of the functions described above; a ROM (read only memory) in which the program is stored; an RAM (random access memory) which develops the program; a storage device (storage medium), such as a memory, in which the program and various kinds of data are stored; and the like. Further, the object of the present invention can be achieved in the following manner: (i) a storage medium for computer-readably storing a program code (an execute form program, intermediate code program, or source program) of the control program, which is software for implementing the aforementioned functions, is provided to the OFDM demodulator, and (ii) a computer (or a CPU or a MPU) of the OFDM demodulator reads out the program code stored in the storage medium so as to execute the program.

Examples of the storage medium encompass: tapes, such as magnetic tapes and cassette tapes; disks including magnetic disks, such as floppy disks (registered trademark) and hard disks, and optical disks, such as CD-ROMs, magnetic optical disks (MOs), mini disks (MDs), digital video disks (DVDs), and CD-Rs; cards, such as IC cards (including memory cards) and optical cards; and semiconductor memories, such as mask ROMs, EPROMs, EEPROMs, and flash ROMs.

Further, the OFDM demodulator may be made connectable to communication networks, and the program code is supplied via the communication networks. The communication networks are not limited to specific means. Examples of the communication network encompass the Internet, an intranet, an extranet, a LAN, an ISDN, a VAN, a CATV communication network, a virtual private network, a telephone line network, a mobile communication network, a satellite communication network, and the like. Further, a transmission medium constituting the communication network is not particularly limited. Specifically, it is possible to use a wired line such as a line in compliance with an IEEE1394 standard, a USB line, a power line, a cable TV line, a telephone line, an ADSL line, and the like, as the transmission medium. Further, it is possible to use (i) a wireless line utilizing an infrared ray used in IrDA and a remote controller, (ii) a wireless line which is in compliance with a Bluetooth standard (registered trademark) or an IEEE802.11 wireless standard, and (iii) a wireless line utilizing an HDR, a mobile phone network, a satellite line, a terrestrial digital network, and the like, as the transmission medium. Note that, the present invention can be realized by a computer data signal which is realized by electronic transmission of the program code and which is embedded in a carrier wave.

As described above, the OFDM demodulator of the present invention includes, at least, symbol number direction integration means for integrating, in a symbol number direction, a first correlation value between the first OFDM signal and a second OFDM signal that is obtained by delaying the first OFDM signal by an effective symbol period, by accumulating the first correlation value every transmission symbol period, so as to find a second correlation value, and offset removal means for removing an offset from the second correlation value, the offset being estimated based on the second correlation value; and

Therefore, even if the correlation value between the OFDM signal and the delay OFDM signal delayed by the effective symbol period includes an amplitude component due to disturbing waves, the correlation value integrated in the symbol number direction becomes a sum of the correlation value of the OFDM signal itself, and a constant offset due to the disturbing waves. The offset removal means removes the offset from the correlation value integrated in the symbol number direction. Accordingly, the correlation value which is integrated and from which the offset is removed is the correlation value of the OFDM signal itself.

Therefore, it is possible to precisely carry out the correction of the narrowband carrier frequency error and symbol synchronization.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is widely applicable to an OFDM demodulator for demodulating a received signal by orthogonal frequency division multiplexing.

1-10. (canceled)

11. An OFDM demodulator for demodulating a first OFDM signal whose transmission unit is a transmission symbol including an effective symbol and a guard interval to which a part of a signal waveform of the effective symbol is copied, comprising:
symbol number direction integration means for integrating, in a symbol number direction, a first complex correlation value between the first OFDM signal and a second OFDM signal that is obtained by delaying the first OFDM signal by an effective symbol period, by accumulating the first complex correlation value every transmission symbol period, so as to find a second complex correlation value;
offset removal means for removing an offset from the second complex correlation value, the offset being estimated based on the second complex correlation value; and
symbol timing generating means for generating symbol timing indicating a boundary between the transmission symbols based on the second complex correlation value from which the offset is removed.

12. An OFDM demodulator for demodulating a first OFDM signal whose transmission unit is a transmission symbol including an effective symbol and a guard interval to which a part of a signal waveform of the effective symbol is copied, comprising:
symbol number direction integration means for integrating, in a symbol number direction, a first complex correlation value between the first OFDM signal and a second OFDM signal that is obtained by delaying the first OFDM signal by an effective symbol period, by accumulating the first complex correlation value every transmission symbol period, so as to find a second complex correlation value;
offset removal means for removing an offset from the second complex correlation value, the offset being estimated based on the second complex correlation value; and
error detecting means for detecting a narrowband carrier frequency error based on the second complex correlation value from which the offset is removed.

13. The OFDM demodulator according to claim 12, further comprising:
stability determination means for (i) determining a stability of the narrowband carrier frequency error detected by the error detecting means and (ii) determining, in accordance with the stability thus determined, how many transmission symbol periods are used by the symbol number direction integration means to accumulate the first complex correlation value.

14. The OFDM demodulator according to claim 12, further comprising:
stability determination means for (i) determining a stability of the narrowband carrier frequency error detected by the error detection means and (ii) resetting, in accordance with the stability thus determined, a sum obtained by accumulating the first complex correlation value every transmission symbol period, the sum being stored in the symbol number direction integration means.

15. The OFDM demodulator according to claim 13, wherein:
the stability determination means determines the stability of the narrowband carrier frequency error by comparing a predetermined threshold value with a difference between a maximum value of and a minimum value of the narrowband carrier frequency error within a certain period.

16. The OFDM demodulator according to claim 13, wherein:
the stability determination means determines the stability of the narrowband carrier frequency error by comparing a predetermined threshold value with a variance of a phase rotation amount within a certain period.

17. An OFDM demodulating method for demodulating a first OFDM signal whose transmission unit is a transmission symbol including an effective symbol and a guard interval to which a part of a signal waveform of the effective symbol is copied, comprising the steps of:
integrating, in a symbol number direction, a first complex correlation value between the first OFDM signal and a second OFDM signal that is obtained by delaying the first OFDM signal by an effective symbol period, by accumulating the first complex correlation value every transmission symbol period, so as to find a second complex correlation value;
removing an offset from the second complex correlation value, the offset being estimated based on the second complex correlation value; and
generating symbol timing indicating a boundary between the transmission symbols based on the second complex correlation value from which the offset is removed.

18. An OFDM demodulating method for demodulating a first OFDM signal whose transmission unit is a transmission symbol including an effective symbol and a guard interval to which a part of a signal waveform of the effective symbol is copied, comprising the steps of:
integrating, in a symbol number direction, a first complex correlation value between the first OFDM signal and a second OFDM signal that is obtained by delaying the first OFDM signal by an effective symbol period, by accumulating the first complex correlation value every transmission symbol period, so as to find a second complex correlation value;
removing an offset from the second complex correlation value, the offset being estimated based on the second complex correlation value; and
detecting a narrowband carrier frequency error based on the second complex correlation value from which the offset is removed.

19. A computer readable storage medium in which an OFDM demodulation program for causing a computer to function as an OFDM demodulator recited in claim 11 is stored,
the OFDM demodulation program causing the computer to function as each of the means of the OFDM demodulator.

20. A computer readable storage medium in which an OFDM demodulation program for causing a computer to function as an OFDM demodulator recited in claim 12 is stored,
the OFDM demodulation program causing the computer to function as each of the means of the OFDM demodulator.
